(19) United States
(12) Patent Application Publication
(10) Pub. No.: US 2026/0067782 A1
(43) Pub. Date: Mar. 5, 2026

(54) METHODS, APPARATUS, AND SYSTEMS FOR PROACTIVE NON-RADIO MEASUREMENTS BASED CONDITIONAL PSCELL CHANGE

(71) Applicant: InterDigital Patent Holdings, Inc., Wilmington, DE (US)

(72) Inventors: Pascal Adjakple, Great Neck, NY (US); Umer Salim, Vallauris (FR); Ravikumar Pragada, Warrington, PA (US)

(73) Assignee: InterDigital Patent Holdings, Inc., Wilmington, DE (US)

(21) Appl. No.: 19/106,001

(22) PCT Filed: Sep. 6, 2023
(86) PCT No.: PCT/US2023/073542

§ 371 Date: Feb. 24, 2025

Related U.S. Application Data
(60) Provisional application No. 63/403,980, filed on Sep. 6, 2022.

(51) Int. Cl. H04W 36/36; H04W 36/00; H04W 36/30; H04W 36/32

(52) U.S. Cl. CPC H04W 36/362; H04W 36/0058; H04W 36/304; H04W 36/32

(57) ABSTRACT

A wireless transmit/receive unit (WTRU) may send assistance information to a network element. The assistance information may indicate that the WTRU can use sensor data for mobility. The WTRU may receive conditional PSCell change (CPC) configuration information, for example from the network element. The CPC configuration information may include one or more of a CPC candidate for device mobility, a CPC candidate for external mobility, and/or a trigger for performing CPC based on the assistance information. The WTRU may perform a CPC, for example based on a cell quality of a serving cell being below a threshold. The WTRU may determine whether to use the CPC candidate for device mobility and/or the CPC candidate for external mobility based on the sensor data and the trigger, for example to perform the CPC.

### CROSS-REFERENCE TO RELATED APPLICATIONS

This application claims the benefit of U.S. Provisional Patent Application No. 63/403,980 filed on Sep. 6, 2022, the entire contents of which are incorporated herein by reference.

### BACKGROUND

5G-New Radio (NR) may be able to operate in two different frequency ranges: sub-6 GHz which may be referred to as frequency range 1 (FR1) and millimeter wave (mmWave) which may be referred to as frequency range 2 (FR2). As the availability of sub-6 GHz range becomes more limited, mmWave frequency bands with wider bandwidths may become more predominant. This led to the extension of FR2 range to 71 GHz in, and the extended range between 51.4 GHz to 71 GHz may be referred to as FR2-2.

One or more Physical Layer (PHY) and Medium Access Control (MAC) layer features may support directional communications. Among the important features is beam management, which is used to acquire and maintain beams. Initial access procedures may be performed, for example, to ensure successful directional transmission. As the transmission and reception are happening through narrow beams, one or more procedures may be used to detect beam failure and to recover from beam failure.

### SUMMARY

Methods and apparatuses are provided for proactive non-radio measurements based conditional primary cell of the secondary cell group (PSCell) Change (CPC) procedure. Methods and apparatuses are provided for configuration of deployment ensembles and coverage ensembles. Methods and apparatuses are provided for performing and reporting non-radio measurements.

A wireless transmit/receive unit (WTRU) may send assistance information to a gNB. The assistance information may include one or more of position, location, panels, field of view, a contextual trigger, or a situational trigger. The WTRU may receive a coverage ensemble and a proactive CPC configuration in response to the assistance information. The WTRU may determine that a link quality falls fellow a predetermined threshold. The WTRU may determine its geographic coordinates and its zone based upon one or more non-radio measurements combined with one or more radio measurements. The WTRU may determine one or more candidate cells and/or one or more candidate beams from a mobility CPC configuration mapped to geographic coordinates. The mobility CPC configuration may be an external mobility CPC configuration or a device mobility CPC configuration. The WTRU may determine a most suitable cell and beam from the candidate cells and beams. The WTRU may execute CPC on the most suitable cell using one or more random access channel (RACH) parameters. The WTRU may determine the one or more RACH parameters for the determined most suitable cell and beam pair. The WTRU may be configured to send assistance information to a network element. The assistance information may indicate that the WTRU can use sensor data for mobility. The WTRU may receive conditional PSCell change (CPC) configuration information, for example from the network element. The CPC configuration information may include a CPC candidate for device mobility, a CPC candidate for external mobility, and/or a trigger for performing CPC based on the assistance information. The WTRU may perform a CPC, for example based on a cell quality being below a threshold. The WTRU may determine whether the use the CPC candidate for device mobility or the CPC candidate for external mobility, for example based on the sensor data and the trigger. Determination of whether the use the CPC candidate for device mobility or the CPC candidate for external mobility may be to perform CPC.

The WTRU may receive local coverage information, for example from the network element. The local coverage information may include one or more of an indication of different zones, and a coverage area of the different zones, and/or a cell or beam associated with each of the different zones. The CPC configuration information may include a priority related to the CPC candidate for device mobility and/or a priority related to the CPC candidate for external mobility.

The trigger for performing CPC may be based on one or more of a radio measurement or a non-radio measurement. The WTRU may determine a zone of the WTRU, for example based on the coverage information and a location of the WTRU. The WTRU may determine whether to use the CPC candidate for device mobility and/or the CPC candidate for external mobility based on the determined zone.

The WTRU may determine whether to use the CPC candidate for device mobility or the CPC candidate for external mobility, for example based on a priority of CPC candidate pairs. The WTRU may determine a random access channel (RACH) parameter based on the CPC configuration information based on a selected CPC candidate. The WTRU may perform CPC to the selected CPC candidate, for example using the determined RACH parameter. Determining whether to use the CPC candidate for device mobility or the CPC candidate for external mobility based on the sensor data may include determining a location of the WTRU using the sensor data.

A WTRU may send assistance information to a network element. The assistance information may indicate that the WTRU can use sensor data for mobility. The WTRU may receive conditional PSCell change (CPC) configuration information, for example from the network element. The CPC configuration information may include one or more of a CPC candidate for device mobility, a CPC candidate for external mobility, and/or a trigger for performing CPC based on the assistance information. The WTRU may perform a CPC, for example based on a cell quality of a serving cell being below a threshold. The WTRU may determine whether to use the CPC candidate for device mobility and/or the CPC candidate for external mobility based on the sensor data and the trigger, for example to perform the CPC.

The assistance information may indicate the that WTRU can use one or more of Global Positioning System (GPS) data, location data, position data, orientation data, velocity data (e.g., velocity measurement(s)), accelerometer data, and/or gyroscope data for mobility. The WTRU/may determine whether to use the CPC candidate for device mobility and/or the CPC candidate for external mobility based on a location of the WTRU determined using the sensor data and the trigger, for example to perform the CPC. The WTRU may receive local coverage information, for example from the network element. The local coverage information may include one or more of an indication of different zones, a coverage area of the different zones, and/or a cell or beam associated with each of the different zones.

The WTRU may determine a zone of the WTRU, for example based on the coverage information and a location of the WTRU. The WTRU may determine whether to use the CPC candidate for device mobility and/or the CPC candidate for external mobility based on the determined zone. The WTRU may determine a zone of the WTRU and/or determine whether to use the CPC candidate for device mobility and/or the CPC candidate for external mobility based on the determined zone to perform the CPC.

The WTRU may determine whether to use the CPC candidate for device mobility and/or the CPC candidate for external mobility based on a priority of CPC candidate pairs, for example to perform the CPC. The CPC configuration information may include a priority. The priority may be related to the CPC candidate for device mobility and/or a priority related to the CPC candidate for external mobility. The trigger for performing CPC may be based on a radio measurement and/or a non-radio measurement. The non-radio measurement may include one or more of a rotation measurement of the WTRU, an orientation measurement of the WTRU, a location measurement of the WTRU, and/or a velocity measurement of the WTRU. The WTRU may determine a random access channel (RACH) parameter based on the CPC configuration information based on a selected CPC candidate, for example to perform the CPC. The WTRU may perform the CPC to the selected CPC candidate using the determined RACH parameter.

A base station may receive assistance information from a WTRU. The assistance information may indicate that the WTRU can use sensor data for mobility. The base station may send conditional PSCell change (CPC) configuration information, for example to the WTRU. The CPC configuration information may include one or more of a CPC candidate for device mobility, a CPC candidate for external mobility, and/or a trigger for performing a CPC based on the assistance information. The base station may receive, for example from the WTRU, an initiation of the CPC. The initiation of the CPC may be based on a cell quality of a serving cell being below a threshold. The CPC configuration information may include a priority related to the CPC candidate for device mobility and/or a priority related to the CPC candidate for external mobility.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a timing diagram of an example WTRU attach procedure.

FIG. 3 is a diagram illustrating an example beam failure detection procedure.

FIG. 4 is a diagram illustrating example parallel running procedures for beam/cell level mobility.

FIG. 5 depicts an example Intra-NR inter-gNB Handover.

FIG. 6 is a diagram illustrating an example conditional handover procedure.

FIG. 7 is a diagram illustrating an example mobility based on WTRU rotation and/or orientation.

FIG. 8 illustrates an example flowchart for a proactive conditional primary cell of the secondary cell group (PSCell) change procedure according to an embodiment.

FIG. 9 is a diagram illustrating an example flow chart for a proactive conditional PSCell change procedure.

FIG. 10 is an example Proactive Conditional PSCell Change (CPC) with system information block (SIB) based Coverage Ensemble.

FIG. 11 is an example proactive CPC with Ensemble Indication as part of Proactive CPC Configuration.

### DETAILED DESCRIPTION

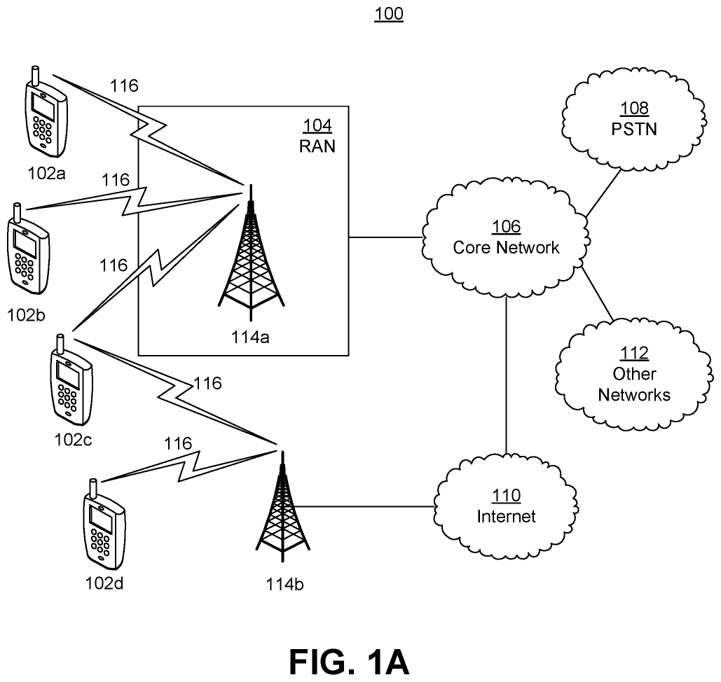

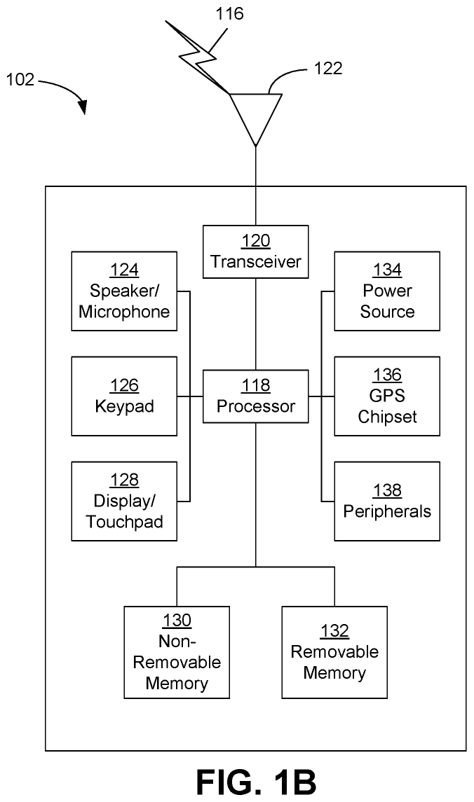

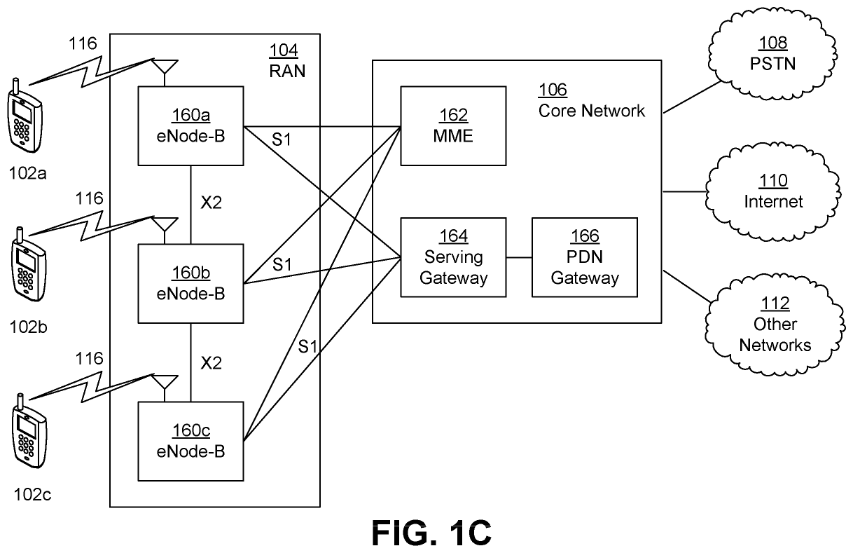

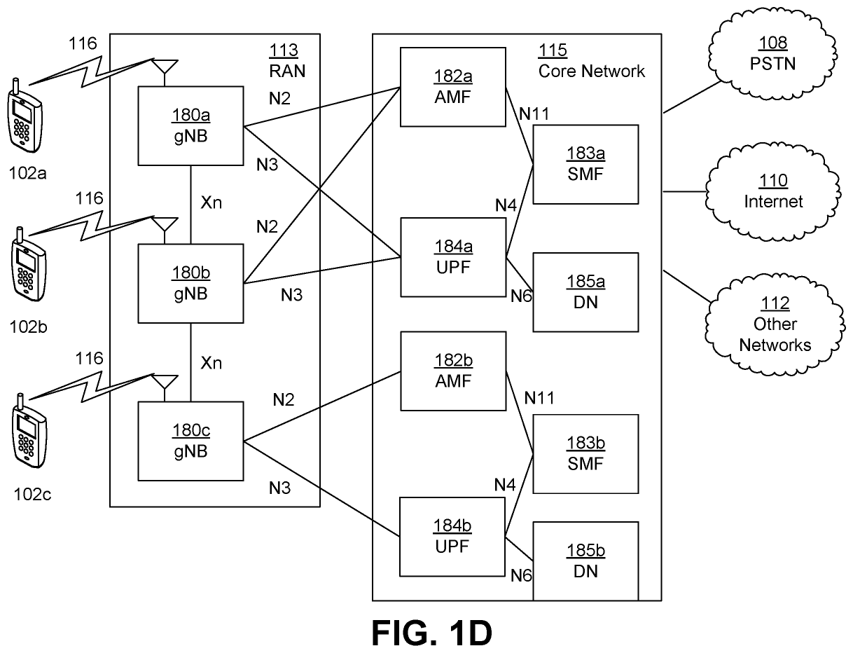

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the downlink (e.g., for reception).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

A WTRU may send assistance information to a network element. The assistance information may indicate that the WTRU can use sensor data for mobility. The WTRU may receive conditional PSCell change (CPC) configuration information, for example from the network element. The CPC configuration information may include one or more of a CPC candidate for device mobility, a CPC candidate for external mobility, and/or a trigger for performing CPC based on the assistance information. The WTRU may perform a CPC, for example based on a cell quality of a serving cell being below a threshold. The WTRU may determine whether to use the CPC candidate for device mobility and/or the CPC candidate for external mobility based on the sensor data and the trigger, for example to perform the CPC.

The assistance information may indicate the that WTRU can use one or more of Global Positioning System (GPS) data, location data, position data, orientation data, velocity data (e.g., velocity measurement(s)), accelerometer data, and/or gyroscope data for mobility. The WTRU/may determine whether to use the CPC candidate for device mobility and/or the CPC candidate for external mobility based on a location of the WTRU determined using the sensor data and the trigger, for example to perform the CPC. The WTRU may receive local coverage information, for example from the network element. The local coverage information may include one or more of an indication of different zones, a coverage area of the different zones, and/or a cell or beam associated with each of the different zones.

The WTRU may determine a zone of the WTRU, for example based on the coverage information and a location of the WTRU. The WTRU may determine whether to use the CPC candidate for device mobility and/or the CPC candidate for external mobility based on the determined zone. The WTRU may determine a zone of the WTRU and/or determine whether to use the CPC candidate for device mobility and/or the CPC candidate for external mobility based on the determined zone to perform the CPC.

The WTRU may determine whether to use the CPC candidate for device mobility and/or the CPC candidate for external mobility based on a priority of CPC candidate pairs, for example to perform the CPC. The CPC configuration information may include a priority. The priority may be related to the CPC candidate for device mobility and/or a priority related to the CPC candidate for external mobility. The trigger for performing CPC may be based on a radio measurement and/or a non-radio measurement. The non-radio measurement may include one or more of a rotation measurement of the WTRU, an orientation measurement of the WTRU, a location measurement of the WTRU, and/or a velocity measurement of the WTRU. The WTRU may determine a random access channel (RACH) parameter based on the CPC configuration information based on a selected CPC candidate, for example to perform the CPC. The WTRU may perform the CPC to the selected CPC candidate using the determined RACH parameter.

A base station may receive assistance information from a WTRU. The assistance information may indicate that the WTRU can use sensor data for mobility. The base station may send conditional PSCell change (CPC) configuration information, for example to the WTRU. The CPC configuration information may include one or more of a CPC candidate for device mobility, a CPC candidate for external mobility, and/or a trigger for performing a CPC based on the assistance information. The base station may receive, for example from the WTRU, an initiation of the CPC. The initiation of the CPC may be based on a cell quality of a serving cell being below a threshold. The CPC configuration information may include a priority related to the CPC candidate for device mobility and/or a priority related to the CPC candidate for external mobility.

A 5G-New Radio (NR) may be able to operate in two different frequency ranges, for example including sub-6 GHz and millimeter wave (mmWave). Sub-6 GHz may be referred to as frequency range 1 (FR1). Millimeter wave may be referred to as frequency range 2 (FR2). As the availability of sub-6 GHz range becomes more limited, mmWave frequency bands with wider bandwidths may become more predominant. FR2 range may be extended to 71 GHz in. An extended range between 51.4 GHz to 71 GHz may be referred to as FR2-2.

One or more Physical Layer (PHY) and/or Medium Access Control (MAC) layer features may support directional communications. Among the important features is beam management. Beam management may be used to acquire and/or maintain beams. Initial access procedures may be performed, for example, to ensure successful directional transmission. As transmission and reception are happening through narrow beams, one or more procedures may be used to detect beam failure and/or to recover from beam failure.

Beam management may include a set of Layer 1 (PHY) and/or Layer 2 (MAC) procedures, for example to establish and/or retain an optimal beam pair for good connectivity. A beam pair may include a transmit beam and a corresponding receive beam in one link direction.

Before a WTRU can communicate with the network, it may perform cell search and selection procedures and/or obtain initial cell synchronization and system information. The WTRU may acquire frame synchronization, for example by finding out the cell identity and/or decoding one or more of the MIB and SIB1.

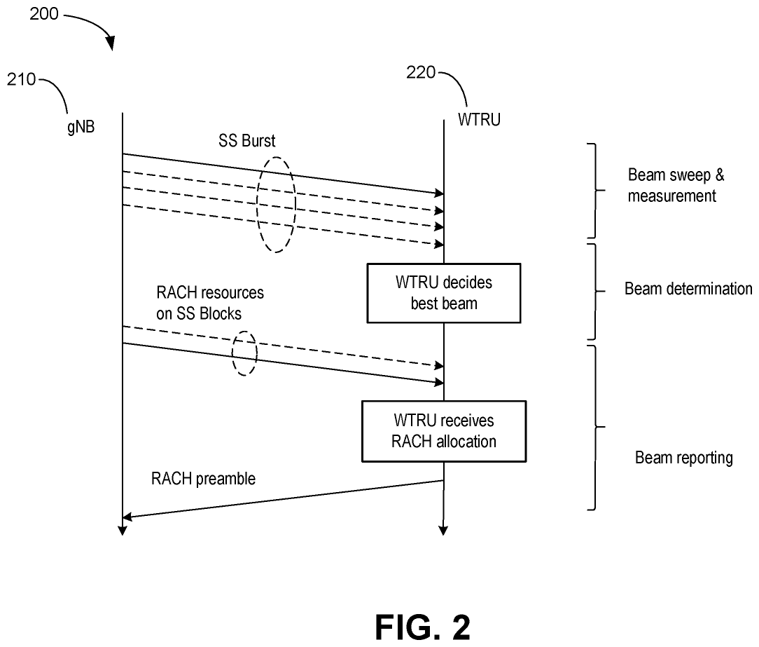

FIG. 2 depicts a timing diagram of an example WTRU attach procedure 200. Detecting the beams from gNB 210 may be included in an (e.g., initial) access procedure, for example when there are multi-antenna system that transmit multiple beams. The (e.g., initial) access procedure may include WTRU detection of one or more (e.g., all) the beams in the search space. The timing diagram shown in FIG. 2 may include various aspects of beam management. The WTRU 220 may (e.g., first) find a suitable beam, decode necessary system information through the beam, and/or (e.g., then) initiate an uplink (UL) connection using received parameters.

A gNB 210 may transmit beams in one or more (e.g., all) directions in a burst, for example at regular defined intervals. A WTRU 220 may read a synchronization signal block (SSB), extract a primary synchronization signal (PSS), a secondary synchronization signal (SSS), a physical broadcast channel (PBCH), and/or demodulation reference signal (DMRS). The PSS may include one of three (e.g., possible) sequences. The PSS may provide a timing estimate. The SSS may include one of 336 (e.g., possible) sequences. The SSS may provide a cell ID (e.g., one of 3*336=1008). The PBCH and/or DMRS may include a master information block (MIB) and/or basic information, for example for decoding the system information block (SIB)-1.

A WTRU 220 may measure beam strength by measuring received signal power through a beam. Beam strength may be based on the synchronization signals, for example in idle mode. Beam strength may be based on the channel state information reference signal (CSI-RS) in downlink and/or sounding reference signal (SRS) in uplink, for example in connected mode. The WTRU 220 may search for the best beam (e.g., periodically), for example using the predefined threshold criteria defined by the gNB 210. The WTRU 220 may identify the beam that has highest reference signal received power (RSRP) as the best beam. The best beam identified by the WTRU 220 may be reported to the gNB 210. Reporting the best beam may be referred to as beam reporting.

A random access channel (RACH) may be an uplink channel. The RACH may be used during initial access and/or when a WTRU is out of sync with the network (e.g., and needs to establish synchronization). There may be one or more RACH interval (e.g., after beam selection) for the WTRU 220, for example in idle mode. A RACH interval may include a (e.g., certain) time and/or frequency offset. The time and/or frequency offset may be transmitted in a RACH preamble. The WTRU 220 may transmit the physical RACH (PRACH) preamble corresponding to the SS block for which the best beam was identified. There may be a one-to-one mapping between the received SS block and the transmitted RACH preamble. The WTRU 220 may report the best beam to the gNB 210. The gNB 210 upon receiving RACH in a given interval may calculate/determine the best beam through which a WTRU 220 might have received the best synchronization signals.

The network may configure the WTRU 220 to perform (e.g., certain) measurements and/or report measurements, for example on a preconfigured interval. This process may be called measurement reporting. The WTRU 220 may report a beam through a measurement report to the gNB 210. For example, the WTRU 220 may report the beam through a measurement report to gNB 210 in connected mode, when the WTRU 220 is already connected with the gNB 210 and/or active data transfer is taking place.

Switching from one beam to another may additionally, or alternatively be called intra-cell mobility and/or beam-level mobility. Beam switching may be based on a trigger condition for a beam and/or a configured beam switching algorithm. Beam switching may be performed when WTRU 220 is in connected mode and/or through L1/L2 procedures. Handover may be used for inter-cell mobility and/or may be an L3 procedure.

Procedures for detecting beam failure (e.g., and recovery) and radio link failure may be provided. For example, when a WTRU 220 and the gNB 210 are communicating through narrow beams, WTRU mobility and/or the changes in the wireless environment may lead to deterioration of the beam pair. Beam level measurements and/or continuous evaluation may be (e.g., key) procedures which, for example may help maintain and/or switch to the best beam pair between a WTRU and the gNB. These procedures may be jointly called beam failure detection and recovery (BFDR).

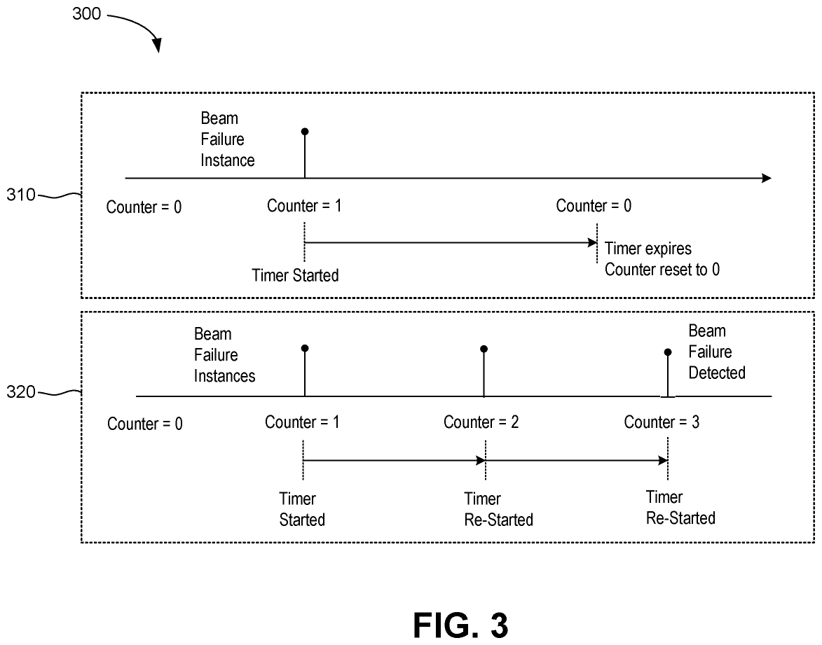

FIG. 3 is a diagram depicting an example beam failure detection 300 at the MAC Layer. The PHY layer of a WTRU may generate a beam failure instance (BFI), for example when measurements from the configured reference signals for this beam fall below a configured threshold. Additionally, or alternatively, the PHY layer of a WTRU may generate a BFI when the quality of a beam deteriorates. The MAC layer may maintain a beam failure instance counter. The MAC layer may increment the BFI counter and/or reset the beam failure detection timer, for example for each instance of the PHY layer reporting BFI. If BFI counter exceeds a configured value, beam failure may be detected. For beam failure detection (BFD), the BFI exceeding the configured value may happen within the beam failure detection timer.

At 310 the MAC layer may receive a BFI from the PHY layer. The beam failure detection timer may expire and/or no beam failure may be generated. At 320 the PHY Layer may report BFI at a rate at which the timer does not expire, the BFI counter may reach the BFD threshold, and/or the MAC layer may generate BFD.

A WTRU may initiate a beam failure recovery (BFR) procedure, for example after detection of a beam failure event. A WTRU may attempt to recover from the beam failure (e.g., once beam failure has been detected), for example if the candidate recovery beams are configured. The WTRU may attempt to validate the configured candidates for a (e.g., given) serving cell, for example according to the configured/defined measurement quality criterion and/or thresholds. Preparation of a BFR MAC-CE and/or a truncated BFR MAC-CE, for example according to the defined conditions where the cells and/or recovery beams may be indicated by the WTRU (e.g., for network knowledge).

The beam recovery procedure may be different based on whether the beam failure is detected on an SpCell or on an SCell. For a beam recovery procedure on an SpCell (e.g., after validating the configured candidate beams), a WTRU may choose a (e.g., suitable) validated candidate beam for RACH transmission. Normal and/or truncated BFR MAC-CE may be sent as part of the RACH procedure. RACH transmission may be based on parameters configured, for example as part of the candidate beam configuration. A successful RACH may inform the network that WTRU has recovered through the candidate beam. For beam recovery procedure on an SCell (e.g., after validation of the candidate beams), a WTRU may transmit the BFR MAC-CE and/or truncated BFR MAC-CE to the network. A RACH procedure may not be initiated for beam failure recovery on an SCell. Further details on beam failure recovery procedure and MAC CE contents are discussed herein.

A WTRU may perform radio link monitoring (RLM), for example based on a synchronization signal block (SSB), and/or the channel state information reference signals (CSI-RS), and/or the signal quality thresholds configured by the network. The PHY layer at a WTRU may make measurements and/or pass/send the measurements to the MAC and the RRC layers. The MAC layer may detect beam failure. The RRC layer may detect radio link failure (RLF). The network may use RRC signaling to configure a WTRU with the RLM reference signals (RLM-RS) and/or associated thresholds. RLM-RS may be SSB and/or CSI-RS. The network may configure timers to be used for RLF detection/determination as part of the primary cell configuration. The PHY layer may generate an out-of-sync (OOS) indication, for example when the radio link quality of one or more (e.g., all) of the monitored RS is below the configured threshold. The PHY layer may generate an in-sync indication, for example when the radio link quality of one or more of the monitored RS is greater than or equal to a configured threshold. The in-sync and/or OOS indications may be passed to the RRC layer.

The criteria to declare RLF may include one or more of the following. For T310 based RLF for example, criteria may be based on the link quality measurements (e.g., using SSBs or/and CSI-RSs). If consecutive out-of-sync indications (e.g., measurement is below the given threshold) are received a preset number of times for example (e.g., N310 times), the RLF timer T310 may be started. If the channel quality recovers before the T310 timer expires for example, the T310 timer may be reset. Otherwise for example, upon expiration of the T310 timer, a RLF may be declared.

For T312 based RLF for example, the WTRU may start the T312 timer upon triggering a measurement report for which the T310 timer is already running. The T312 timer may allow the WTRU to differentiate between an RLF caused by a handover failure and/or an RLF caused by coverage hole. The T312 timer may be (e.g., typically is) shorter than the T310 timer. If the channel quality of the source gNB is worse than a threshold for example, the shorter T312 timer may expire earlier and/or a RLF may be timely declared.

For random access procedure failure for example, if multiple RACH attempts to connect to a gNB fail consecutively (e.g., a predetermined number of times), a RLF may be declared. For failure in Beam Failure Recovery procedure for example, a failure in recovering to a suitable beam after detecting beam failure may lead to an indication of link failure. An RLF may be declared due to reaching the maximum number of re-transmissions, for example from a radio link control (RLC) layer.

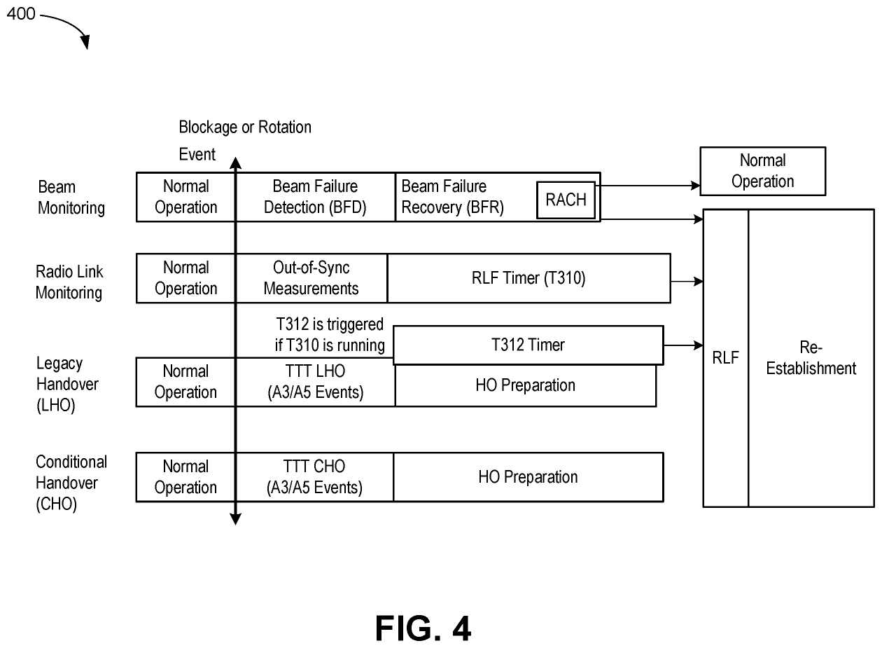

FIG. 4 depicts example parallel running procedures 400 for Beam/Cell Level Mobility. BFDR, RLM, and/or handover procedures may run concurrently, for example when the beams and links are deteriorating. Each (e.g., individual) procedure may lead to an RLF. A link outage may interrupt the measurement reporting and/or HO initiation, for example when the WTRU is configured to use legacy handover (HO). Link outage may result in failure of the HO operation. The BFDR procedure may attempt to recover through BFR (e.g., in parallel). An RLF may be declared by the BFDR procedure, for example if the recovery attempts fail. A WTRU may evaluate the execution condition for the conditional handover and/or may handover to the target cell if the execution condition is satisfied, for example when the WTRU is configured to use conditional handover (CHO) (e.g., once the serving link starts to degrade).

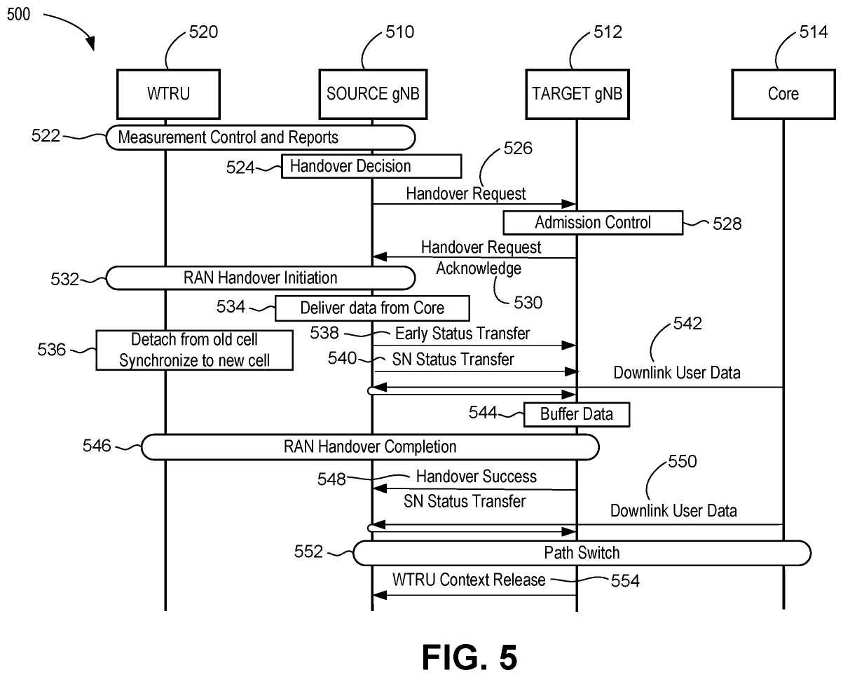

FIG. 5 depicts an example Intra-NR inter-gNB Handover 500. Intra-NR Inter-gNB handover may be referred to herein as legacy handover. Cell/gNB level mobility may utilize explicit RRC signaling to be triggered, for example when a WTRU 520 is in RRC connected mode. At 522 the WTRU 520 may report the cell quality measurement to its serving (e.g., source) cell, for example when a neighboring cell quality is offset better for a preset duration of time-to-trigger (TTT). Different events called A1, A2, A3, A4, A5, etc. may be defined for WTRU measurement report triggering. The TTT and/or the cell specific offsets may be specified during measurement configuration. Source gNB 510 may make a handover decision at 524. At 526 the source gNB 510 may issue a handover request to the target gNB 512, for example if a handover (HO) decision is made based on the measurement report. Target gNB 512 may make an admission control decision at 528. At 530 the target gNB 512 may send a handover request acknowledgement to the source gNB 510, for example if the WTRU 520 is admitted by the target gNB 512. The handover request acknowledgment may include an RRC message (e.g., to be sent to the WTRU). At 532 the source gNB 510 may (e.g., next) initiate handover and/or send the RRC reconfiguration message to the WTRU 520. The RRC reconfiguration message may include a set of (e.g., dedicated) RACH resources. The WTRU 520 may synchronize to the target cell and/or complete the RRC handover procedure.

At 536 the WTRU 520 may detach from the old cell and/or synchronize to a new cell. At 538 there may be early status transfer from the source gNB 510 to the target gNB 512. At 540 there may be SN status transfer from the source gNB 510 to the target gNB 512. Downlink user data may be sent from core 514 to the source gNB 510 and/or the target gNB 512 at 542. The downlink user data may additionally, or alternatively be sent from the source gNB 510 to the target gNB 512. The target gNB may buffer data at 544. At 546 there may be RAN handover completion.

A handover success message and/or SN status transfer may be sent from the target gNB 512 to the source gNB 510 at 548. Downlink user data may be sent from core 514 to the source gNB 510 and/or the target gNB 512 at 550. The downlink user data may additionally, or alternatively be sent from the source gNB 510 to the target gNB 512. At 552 there may be a path switch between one or more of the source gNB 510, the target gNB 512, and/or the core 514. There may be WTRU context release from the target gNB 512 to the source gNB 510 at 554.

The HO process may fail due to poor channel qualities of the target gNB and/or the source gNB. In a scenario with directional links, handover problems may be exacerbated, for example because the link qualities of the target and/or source gNBs may deteriorate quickly due to mobile blockers or WTRU rotations. The blockage of a target gNB during a handover procedure may result in a handover failure (HOF). A handover failure timer may be started, for example when the WTRU 520 receives an RRC reconfiguration message. If the timer expires before the handover is completed, a HOF may be declared. The WTRU 520 may perform connection re-establishment. The source gNB 510 may not be able to initiate a handover procedure in time based on the most recent measurement reports, for example after a (e.g., sudden) WTRU rotation or a blockage. Additionally, or alternatively, measurement reports from the WTRU 520 may be lost due to poor link quality. The WTRU 520 may need to either wait for the source gNB 510 to recover from outage and/or declare an RLF, for example without handover assistance from the source gNB 510 (e.g., even when there are potential target gNBs with good channel qualities).

As a potential solution to the target gNB 512 being blocked, dual-active protocol stack (DAPS) handover may be provided. In DAPS handover, the WTRU 520 may not release the source cell connection until random access to the target gNB 512 is completed. If the target gNB 512 link deteriorates before random access is completed for example, WTRU 520 may fall back to the source gNB 510.

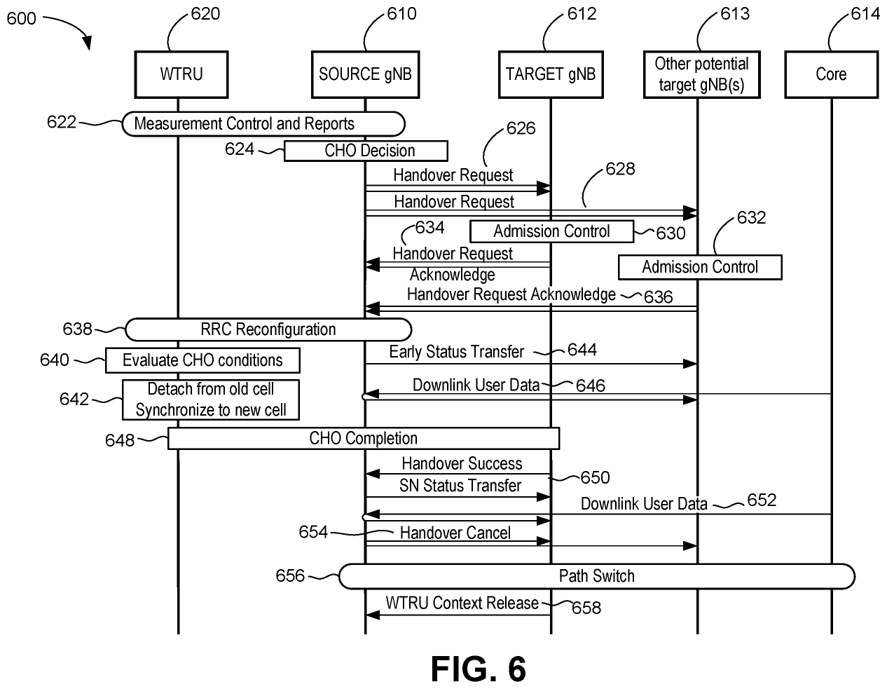

FIG. 6 depicts an example Intra-NR RAN conditional handover 600. Conditional handover (CHO) may address the blockage of the source gNB 610. In CHO for example, the WTRU 620 may be configured to execute handover when one or more handover execution conditions are met, for example at 622. The source gNB 610 may (e.g., proactively) configure the WTRU 620 to evaluate CHO execution conditions defined for candidate gNBs 612, 613. A CHO decision may be made at the source gNB 610 at 622. At 624 the WTRU 620 may initiate handover to a target gNB 612 without the signaling from the source gNB 610, for example once the conditions are met (e.g., when the target gNB 612 is an offset better than the source gNB 610). Additionally, or alternatively, at 628 the WTRU 620 may initiate handover to another gNB 613 without the signaling from the source gNB 610, for example once the conditions are met. Even when the source gNB 610 is in outage state due to a sudden blockage or a rotation, the WTRU 620 may still successfully complete a handover with the target gNB 612, for example if a CHO execution condition is satisfied. There may be admission control at the target gNB 612 at 630. Additionally, or alternatively, there may be admission control at another gNB 613 at 632. The target gNB may send a handover request acknowledgement message to the source gNB 610 at 634. Additionally, or alternatively, the other gNB 613 may send a handover request acknowledgement message to the source gNB 610 at 636.

There may be an RRC reconfiguration at 638. The WTRU 620 may evaluate CHO conditions at 640. At 642 the WTRU 620 may detach from the old cell and/or synchronize to a new cell. At 644 there may be early status transfer from the source gNB 610 to the target gNB 612 and/or another gNB 613. Downlink user data may be sent from core 614 to the source gNB 610 and/or the target gNB 612 at 646. The downlink user data may additionally, or alternatively be sent from the source gNB 610 to the target gNB 612 and/or other gNB 613. At 648 there may be RAN handover completion.

A handover success message and/or SN status transfer may be sent from the target gNB 612 to the source gNB 610 at 650. Downlink user data may be sent from core 614 to the source gNB 610 and/or the target gNB 612 at 652. The downlink user data may additionally, or alternatively be sent from the source gNB 610 to the target gNB 612 and/or other gNB 613. A handover cancel message may be sent from the source gNB 610 to the target gNB 612 and/or other gNB 613 at 654. At 656 there may be a path switch between one or more of the source gNB 610, the target gNB 612, the other gNB 613, and/or the core 614. There may be WTRU context release from the target gNB 612 to the source gNB 610 at 658.

Although CHO is resilient to mobile blockers and can significantly reduce the number of RLFs originating from fast deteriorating links, CHO success may be based on one or more of the availability of candidate gNBs before the failure of the source link, the link quality of the target links, and/or the conditional thresholds for the target gNBs. Even if there are candidate gNBs for example, a WTRU may maintain the link quality with the selected candidate gNB until the handover completion. A (e.g., careful) configuration of the conditional thresholds for the handover execution may also be utilized. Higher threshold values may lead a WTRU failing to (e.g., timely) execute the handover to a target gNB resulting, for example in a failed handover. Lower threshold values may lead to a sub-optimal choice of a new serving gNB and/or potentially useless handovers.

Carrier aggregation may be used in wireless communication, for example to increase the data rate per WTRU. In carrier aggregation multiple frequency blocks (e.g., called component carriers) may be assigned to the same WTRU. The maximum possible data rate per WTRU may be increased as more frequency blocks are assigned to a WTRU. Additionally, or alternatively, carrier aggregation may enable load balancing among different carrier components. Carrier aggregation may enable the network operator to use different component carriers which, for example may be fragmented because of one or more of availability, regulations, and/or licensing perspective.

Dual connectivity (DC) may be similar to carrier aggregation though there may be important differences. In DC, a multiple Rx/Tx capable WTRU may be configured to utilize resources provided by two different nodes, for example connected via non-ideal backhaul. Each node may provide 4G LTE and/or 5G NR based radio access. One node may act as the master node (MN) and/or the other node as the secondary node (SN). The MN and SN may be connected via a network interface. At least the MN may be connected to the core network. DC may be based on the assumption of non-ideal backhaul between the different nodes. DC may additionally, or alternatively, be used in case of ideal backhaul. In DC for example, a group of serving cells associated with the MN may be called master cell group (MCG). The MCG may include the primary cell (PCell) and/or one or more serving cells (SCells). PCell may be the cell, operating on the primary frequency, in which the WTRU performs the initial connection establishment procedure, initiates the connection re-establishment procedure, and/or may be the cell indicated as the primary cell in the handover procedure. A group of serving cells associated with the SN may be called secondary cell group (SCG). The SCG may include a primary cell and/or one or more SCells. The primary cell of the SCG may be a PSCell.

Conditional PSCell addition (CPA) and/or conditional PSCell change (CPC) procedures may be where a WTRU is provided with the configuration of candidate PSCells, for example with CPA/CPC execution conditions. Upon receiving the configuration, a WTRU may begin evaluating the configured execution conditions. When the execution condition for a candidate PSCell is satisfied for example, a WTRU may perform the CPA/CPC procedure.

The network may change PSCell, for example when the current PSCell is suffering from poor conditions (e.g., in PSCell change procedure). There may be increased latency, for example prior to connection update with the new PSCell. A WTRU may not have sufficient resources on the SCG and/or performance may suffer, for example during the transition time. The configuration may be provided to a WTRU prior to PSCell undergoing bad radio conditions, for example with CPC. A number of cells may need to be configured as candidate PSCells, as for example the network may not know the (e.g., precise timing) and/or movement for a WTRU nor for the target suitable PSCell.

Larger antenna arrays (e.g., number of antenna elements ranging from tens to hundreds) may be used to form high gain highly directional narrow beams which ensure desirable coverage level at such high frequencies, for example at higher frequencies such as the anticipated sub-THz and THz frequency range for 6G systems, due to high attenuation and/or path loss. As we move higher in the frequencies, the beam may become (e.g., further) narrower. Highly directional links resulting from narrow beams at the WTRU and/or gNB may be (e.g., much) more sensitive to the dynamic changes in the environment compared to the conventional links. Another important aspect of such high frequency systems may be network densification with shorter coverage areas for each transmission reception point (TRP).

Mobility events (e.g., translational and/or rotational) and/or blockage events may be more frequent, for example for highly densified systems with highly directional narrow beams. Link quality may degrade quicker and/or more frequently, for example as a result of the links/beams being highly directional. The time budget for one or more of performing measurements, reporting measurement results (e.g., in the case of network control mobility), processing the measurements, making mobility decision, and/or executing the mobility decision may be (e.g., extremely) tight. A traditional radio measurement-based approach to mobility/beam management may be impractical for primary and/or secondary cell groups in DC operation. Some applications may require even higher quality of service requirements. Mobility events may be the result one or more of translational motion, rotational motion, and/or the change in the wireless medium. The WTRU rotations may come from rotational movements of handset/wearable devices, for example smartphone, game controllers, VR/XR headsets, and/or etc. Movements may originate from hand gestures, head movements, and/or etc. The WTRU rotations may lead to channel variations between the serving gNB and the WTRU which, for example may cause beam misalignment and/or link/connection failures. Other types of dynamic changes may originate from translational mobility. Another type of change may result from a serving link/beam being blocked by a moving object and/or a mobile blocker in the surrounding environment. Changes may happen in any combination, which may result in degradation/failure of (e.g., multiple) beams/links. Applications with stringent quality of service (QoS) targets may require faster recovery, otherwise for example QoS targets may not be met and/or there may be a compromised user experience. In such highly directional systems for example, the robustness and/or reliability of the existing mobility procedures, which may (e.g., heavily) rely on radio signal measurements may be challenged. New mobility methods that rely less on radio signal measurements may be utilized as herein.

Mobility may result in (e.g., sudden) link degradation for the serving/source gNB (e.g., for primary and/or secondary cell groups in DC operation). The WTRU may not have discovered the neighboring cells/beams available in the vicinity from neighboring TRPs and/or from neighboring gNBs. The reason for non-detection could be insufficient time for the network to configure the measurements and/or gaps, and/or for the WTRU to make these measurements if configured. For DC operation, the missing configurations to recover from the degrading secondary link quality through configured CPA/CPC candidates may result in loss of connection to the secondary cell group and/or may require larger delays (e.g., despite cells' coverage available in the vicinity from the same network). Systems and methods as herein may avoid such problems of missing suitable CPA/CPC configurations at WTRUs.

Another issue for operation in the dense networks with large number of narrow beams may be power consumption, for example for transmission/reception and/or for making measurements on one or more (e.g., all) narrow beams (e.g., from different TRPs/gNBs). Devices may make measurements on neighboring beams/cells of (e.g., both) the primary and/or secondary cell groups. For example, due to directionality and/or pathloss, the measurements may be made through (e.g., suitable) receive beams. A device may consume a lot of power in terms of reception and/or computation for making measurements over the neighboring cells and their beams. Beam steering for measurement may add outage from the perspective of the serving beam/link. Lean procedures may be defined to reduce the WTRU power consumption for beam/cell measurements over the neighboring beams/cells.

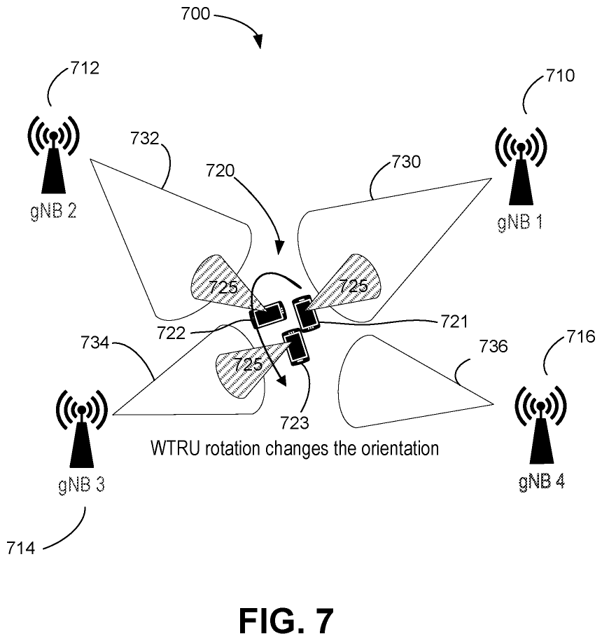

FIG. 7 depicts an example mobility 700 based on WTRU rotation and/or orientation. Example PSCell links are shown in FIG. 7. The gNB 710 may provide PSCell for the WTRU 520, for example operating in DC. The primary cell group and PCell links for the WTRU 720 are not shown in FIG. 7 (e.g., to focus on the secondary link and CPA/CPC procedures).

An initial position/orientation of WTRU may be indicated by 721, and/or the next two orientations may be indicated as 722 and 723 respectively. The beams from these gNBs 710, 712, 713, 714 and/or WTRU beams 725 may be indicated as blank and dashed beams respectively for each gNB 710, 712, 714, 716 and for each WTRU position/orientation 721, 722, 723. The WTRU 720 in position 721 may not be able to discover the beam 732 from gNB 712 and/or the beam 734 from gNB 714) whose coverage, for example may be in a non-overlapping angular space than WTRU's beam 725. Non-detection may be the result of network not having the time to configure WTRU 720 for measurements and/or proper measurements gaps configuration, etc. The WTRU 720 position/orientation may be 722. At position 722, the WTRU 720 may lose the angular coverage space of gNB 710's beam, for example there may be link failure for PSCell serving beam 730 from gNB 710. In position/orientation 722, WTRU 720 may be in coverage space of a suitable beam 732 from gNB 712. If for example a cell/beam is not discovered, no measurements may be reported and/or the network may not have configured the cell/beam(s) from gNB 712 to the WTRU 720 for CPC procedure. A missing configuration for suitable conditional PSCell candidates may result in a (e.g., large) delay before a WTRU may establish DC (e.g., again) with the new suitable cell. A resulting outage may be unacceptable for the service/application running with higher QoS requirements and/or may lead to user dissatisfaction.

Examples described herein may minimize mobility interruptions/outages over the WTRU link to PSCell for DC operation targeting conditional PSCell change procedures in a seamless predictive manner and/or the interruptions and/or outages during these transition events may be minimized. Procedures herein may depart from exclusively using radio measurements, by using other non-radio-based measurement information, for example one or more of network deployment data, positioning, future device movements data, and/or other sensing information.

Minimization of mobility interruption may be a key subject in wireless communication systems. Evolution of wireless systems with the new applications may utilize one or more of low-latency, high-reliability, and/or high-availability, and may result in greater focus and/or activity to this subject.

Systems and methods for proactive mobility handling focusing on radio link to PSCell in DC operation are provided herein. Systems and methods may combine knowledge of network deployment of nodes/cells/beams and the ability of a WTRU to track its movements and/or determine updated geographic location/position and/or orientation.

The WTRU ability to fast detect its location/orientation may be used to choose the suitable node/cell/beam to which the WTRU should connect. Mobility decisions may be made at the WTRU. The network may send a (e.g., suitable and/or finite) piece of its deployment/coverage ensemble to the WTRU(s), for example to make decisions with respect to its latest positions/orientation and/or a change in the network environment. Details on one or more of ensemble contents, configuration, maintenance, signaling mechanisms, and/or WTRU post-processing may be provided herein.

A WTRU may use network shared information with one or more of the WTRU's latest movements, positions, orientation, and/or any change in the network environment (e.g., to minimize mobility interruptions over the secondary link), for example after acquiring the network ensemble, which may represent the ensemble for secondary link in DC. Systems and methods herein may include a framework of making measurements on (e.g., legacy) measurement quantities and/or on several newly defined quantities, for example one or more of position, location and/or orientation. A WTRU may combine legacy measurement quantities with the newly proposed non-radio measurement quantities to design (e.g., special and/or suitable) events and/or triggers which, for example may allow minimization interruption by triggering suitable mobility procedures to one or more of (e.g., suitable) target nodes, cells and/or beams for the secondary link. Measurement framework, quantities, and/or joint events on radio and/or non-radio measurement quantities are described herein.

Systems and methods as herein may provide system level design for conditional PSCell addition (CPA) and/or conditional PSCell change (CPC) procedures. The system level design for conditional PSCell addition (CPA) and/or conditional PSCell change (CPC) procedures may build upon frameworks for one or more of the following. The system level design for conditional PSCell addition (CPA) and/or conditional PSCell change (CPC) procedures may build upon frameworks for deployment/coverage zones, which for example may be indicated by the network to a WTRU (e.g., through signaling). The system level design for conditional PSCell addition (CPA) and/or conditional PSCell change (CPC) procedures may build upon frameworks for non-radio measurements and/or events, which for example may be combined with radio measurements. Radio measurements may be estimated and/or evaluated at the WTRU. The system level design for conditional PSCell addition (CPA) and/or conditional PSCell change (CPC) procedures may perform a proactive conditional PSCell change procedure (e.g., as described herein).

Deployment and coverage zones may be provided. For example, deployment and coverage zones may be indicated. The cellular networks may be planned networks with operators deploying the network nodes at suitable locations to provide sufficient coverage to their subscribers. The network operator may have (e.g., precise) knowledge of its deployment of cells, and/or the beams within those cells, for example in terms of coverage zone attributes. Coverage zone attributes may include one or more of the locations (e.g., reference location) of cells and/or transmission points (TRPs), potential spatial directions of transmission (e.g., by azimuth), elevation angles and/or location coordinates of the TRPs, beam width information (e.g., 3-dimensional (3D) beam width information, for example in horizontal and vertical directions), transmission range information, and/or coverage shape information (e.g., location coordinates of points that constitute the coverage border of a beam, cell or TRP).

The deployment ensemble may include information about the location of TRPs and/or coverage/orientation of beams. The location of TRPs may be represented by (e.g., in terms of) 2D coordinates, 2D coordinates may include latitude and/or longitude coordinates. The location may be represented in 3D coordinates, for example with the addition of altitude and/or height to 2D coordinates. 2D and/or 3D representations may be in global and/or local coordinate systems.

The beams from a given TRP may be represented using azimuthal and/or elevation angles. Suitable references may be used, for example one or more of cardinal directions, zenith, and/or reference directions. References may be included in a configuration. Angles may be provided with (e.g., suitable) refinement and/or quantization, for example to capture the mobility procedures and/or signal strengths in and/or out of the coverage for a given beam. Additionally, or alternatively, beam widths in (e.g., these) directions may be provided explicitly for the beams. A WTRU may prepare a local ensemble where, for example the WTRU knows coverage of different beams from different TRPs. Additional or alternative attributes, for example range and/or power may be added to cell/beam (e.g., to refine the deployment ensemble).

The coverage ensemble may provide the indication of geographic coverage from different TRPs for different beams. The coverage ensemble may provide the coverage boundary of different TRPs and/or different beams. The coverage ensemble may incorporate one or more of the nature of the terrain, topographic aspects, buildings, and/or other geographic parameters on the deployment ensemble, for example to prepare suitable zones and/or boundaries associated with the coverage of different beams from different TRPs.

The representation of the coverage ensemble may be in the form of suitable geometric shapes. To indicate the shapes delimiting the cells/beam level coverage, different reference shapes may be defined. The reference shapes may be in the form of one or more of circles, ovals, ellipse, and/or ellipsoids with suitable parameterization. The coverage ensemble may be indicated using shapes with suitable attributes. Attributes may provide links to the cell/beam identities to which a given shape/area is associated. The terms deployment ensemble and coverage ensemble may be used interchangeably herein. A coverage ensemble may be associated with a coverage ensemble area. A coverage ensemble area may correspond to one or more of one or more cells, a RAN Notification Area (RNA), a tracking area (TA), a PLMN, and/or etc.

The coverage ensemble may have (e.g., be defined at) different granularities. The granularity of the coverage ensemble may be included in the coverage ensemble configuration. The coverage ensemble may have (e.g., be defined at) a cell level. Information of geographic coverage from different gNBs/TRPs may be indicated to WTRUs with suitable signaling. The cell level coverage may be useful for different hand-over and cell change procedures.

The coverage ensemble granularity may be indicated in coverage zones. For cell level procedures, the coverage ensemble zones may include cell level granularity. For beam level procedures where for example a WTRU may need to track, maintain or switch beams, the coverage ensemble granularity may be defined at beam level. Zones in a coverage ensemble be associated with different beams.

Zones may be attributed to given beams from given TRPs. A refined granularity may be achieved by defining and/or associating zones to different directions from each gNB and/or TRP. The zones in the coverage ensemble may be indicative of the geographic area which may, for example correspond to a (e.g., given) set of reference signals. Each zone may indicate the coverage area for an SSB beam, for example for beam level zones (e.g., in one design). Each zone may indicate the coverage area for an SSB beam and/or a CSI-RS beam (e.g., in another beam level zone design). A SSB/CSI-RS beam may be the coverage for the corresponding SSB/CSI-RS signals.

Each zone may be identified with an identity. The identity may be provided as part of the configuration. Each zone identity may be a deterministic combination of one or more of identities of cells, TRP, and/or the SSB/CSI-RS beam that it is attributed to. A formula to compute zone identity may be known to the network and/or the WTRU (e.g., a-priori). Modulating parameters including one or more of lengths, widths, number of SSB beams, and/or etc. may be part of the system information and/or the configuration. Modulating parameters may be additionally, or alternatively used to determine the zone identity.

A different granularity for the zones may be at one or more of gNB, TRP, and/or cell level. For cell level zones for example, the zone may indicate the area where this cell has sufficient coverage. The cell level zone may group one or more (e.g., all) the SSB/CSI-RS zones associated with a given cell. The cell level zone may represent the area where any of the SSB/CSI-RS signals for this cell can be received with a known/configured quality. The zone representation may be extended to larger granularities for one or more of RNA, TA, and/or PLMN based coverage zones. The cell level zone identity may be the cell identity or a deterministic modification of the cell identity, for example by combining with (e.g., some) other parameters. The same design may be used for zones to represent the coverage for one or more of RNA, TA, PLMN, and/or etc.

The zones may be defined for each location using longitude and/or latitude values. Zone length information may be provided as part of the configuration. The formula to compute the zones may be pre-defined and/or signaled as part of the configuration from a pre-defined set. This design may facilitate a zone identity's computation. For this design, the longitude and latitude values may be the geodesic distances from the geographical coordinates (0,0), for example as in used in the NR sidelink framework. Suitable parameters may be provided as part of the configuration to choose the zone modularity and/or the longitude and latitude directions. A parameter (e.g., only one single parameter) may be used to choose the same modularity along longitude and latitude directions. The parameter may be a fixed value, for example to ease the configuration. One or more (e.g., all) of the devices (e.g., WTRUs) may compute their zones and/or the zones for any location against the longitude and latitude coordinates of that location.

The deployment ensemble may include the information about the location of TRPs and/or coverage/orientation of beams. The location of TRPs may be represented in terms of 2D coordinates. 2D coordinates may include the latitude and longitude coordinates. The location may be represented in 3D coordinates, for example with the addition of altitude and/or height to 2D coordinates. 2D and/or 3D representations may be in global and/or local coordinate systems. If the zones' configuration follows the sidelink design for example, the TRP locations may be provided against the zones instead of the longitude and latitude coordinates.

The beams from a given TRP may be represented using azimuthal and/or elevation angles. Suitable references may be used, including for example, cardinal directions and zenith, or reference directions. References may be provided as part of the configuration. Angles may be provided with suitable refinement and/or quantization, for example to capture (e.g., meaningfully) the mobility procedures and/or signal strengths within and/or out of the coverage for a given beam. The beam widths in these directions may be additionally, or alternatively provided (e.g., explicitly) for the beams.

The network may directly provide the configuration, for example in the form of rich shapes which may capture one or more (e.g., all) of the (e.g., specific) aspects of one or more of the local terrain, shadowing from buildings, and/or other objects. The network may (e.g., precisely) know the deployment of its cells/TRPs and beams and/or have access to topographical data using one or more of a navigation system, cameras, and the ongoing measurements on cells/beams from the devices (e.g., which let it know very precise coverage ensemble). Use of historic data (e.g., all historic data), for example in the form of network measurements and/or cells/beam transitions, may be used to update and/or refine (e.g., such detailed) coverage ensembles. This approach may have a large signaling overhead. The amount of information that needs to be exchanged may be huge, for example as the precise coverage for even a single beam may require a set of objects and/or their attributes communicated to a WTRU. The large signaling overhead may require several message exchanges, for example at RRC level, which may lead to increased configuration latency.

If the zones' configuration follows the sidelink design for example, the network may provide different cells and/or beams coverage indication, which may provide the association of these cells and/or beams to zones.

The ensemble configuration may be a hybrid of the two earlier approaches where some part may be indicated in the form of network deployment based configuration and/or some part may be indicated using the coverage ensemble based configuration.

In examples, the initial configuration for the coverage ensemble may be communicated to a WTRU, for example in the form of dedicated RRC signaling. A WTRU in RRC active state with mobility may be provided the initial coverage ensemble configuration. Signaling may appear dedicated to the WTRU. The network may provide the same information to a set of WTRUs. These WTRUs may be in the vicinity of each other and/or the same coverage ensemble may be relevant for them.

Additionally, or alternatively, the network (e.g., the base station) may broadcast coverage ensemble information. A new coverage ensemble system information block (SIB) may be specified. The coverage ensemble information broadcasted by a cell and/or a TRP may be configured to reflect the local deployment environment of the cell or TRP broadcasting the coverage ensemble.

The initial configuration may provide a coarse coverage ensemble. The coarse coverage ensemble may be refined to (e.g., suitable) granularities and/or coverage extensions (e.g., to be fully useful). The coverage ensemble may be refined (e.g., suitably) through dedicated signaling. The refinement may be network initiated, for example when it is configuring certain applications/flows with QoS constraints necessitating proactive mobility. A WTRU may request the refinement of its coverage ensemble.

The network deployment ensemble may be shared with WTRUs, for example following the configuration solutions as herein. Additional attributes may be added to the cell configuration and/or by new configurations may be introduced. Configurations may have these geographic attributes. Configurations may be provided the links of these TRP/beam level configurations to the legacy cell configurations. A WTRU may have a detailed effective coverage ensemble that may be referred to as an on-the-ground coverage ensemble, for example to use in mobility events and/or effective selection of one or more of beams, cells, and/TRPs. The coverage ensemble may take into account one or more of the TRP locations, beam attributes, and/or the physical nature of the environment around (e.g., including the specifics of the terrain, the buildings with their physical attributes). The environment may shadow, block, and/or reflect the beams. Solutions herein may enable a WTRU to acquire/fabricate the on-the-ground coverage ensemble.

The network provided deployment configuration may be made (e.g., very) rich and/or refined. The network provided deployment configuration may be provided in the form of rich shapes which, for example may capture the specific aspects of the local terrain, shadowing from buildings and/or other objects. Different reference shapes can be defined, for example to indicate the shapes delimiting the cells/beam level coverage. The reference shapes may be in the form of one or more of circles, ovals, ellipse, and/or ellipsoids with suitable parameterization. The network may (e.g., then) indicate these shapes with suitable attributes and/or provide their links to the cell/beam identity. The network may know (e.g., precisely) the deployment of its cells/TRPs and/or beams. The network may have access to topographical data, for example using one or more of a navigation system, cameras, and/or the ongoing measurements on cells/beams from the devices which let it know very precise coverage ensemble. Historic data, for example in the form of network measurements and/or cells/beam transitions may be used to update and/or refine such detailed coverage ensembles. This approach may have a large signaling overhead. The amount of information to be exchanged may be huge, for example as the precise coverage for even a single beam may require a set of objects and their attributes communicated to a WTRU. The large signaling overhead may utilize a number of message exchanges at RRC level, for example leading to increased configuration latency.

The network may provide to WTRU(s) a snapshot of the nodes deployment and/or limited information about the beams it transmits. This approach may (e.g., mainly) be used when network is providing its deployment configuration. The network may provide the information about the TRP locations, beam angles and/or beam specific parameters without modulating the coverage with the features of the local terrain. The signaling overhead and/or latency performance of this approach may be better (e.g., than the former), for example due to little information compared to the approach where the network provides the detailed coverage ensemble.

The devices may receive deployment features/parameters for TRPs/beams and/or use the local knowledge through other technologies (e.g., local stored topography, positioning systems, and/or cameras) prepare a refined coverage ensemble which, for example may add the topographical aspects to the deployment configuration. WTRUs may receive the effective ensemble, which for example delimits different coverage zones associated to different beams and cells. WTRUs may receive the effective ensemble after the local processing and fabrication. The refined coverage ensemble may (e.g., then) be used in the beam and/or cell level mobility procedures at the WTRU. This local physical coverage ensemble may be refined with the mobility and/or additional information, for example obtained from other sensors. Parameters and/or the information from local sensors may be utilized together (e.g., combine). Local sensors, additional storage, and/or computing capability may be utilized, for example to prepare (e.g., effective) ensembles by combing network deployment with the information from local sensors.

Hybrid solutions may be standardized to get the refined coverage ensemble at the devices. For example, if there are devices which are not equipped with necessary local sensors, or they do not have necessary computing power to process and fabricate an ensemble themselves, the network may send the refined ensemble to such devices. Devices having necessary local sensors and/or computing/storage power may receive (e.g., limited) deployment features from the network and/or prepare the effective ensemble locally. The hybrid solutions may also be used, for example depending on one or more of WTRU power consumption requirements, battery quality, remaining battery, and/or as a function of active applications and/or/their attributes.

Upon detection of change in coverage ensemble area for example, the WTRU may re-acquire a coverage ensemble for its current location. The re-acquisition may be in the form of dedicated RRC signaling. The re-acquisition may be in the form of re-acquiring the coverage ensemble SIB. The WTRU detection of change in coverage ensemble area may include one or more of the following. The WTRU may detect a change in serving cell and/or (re) select to a cell that, for example does not belong to the current coverage ensemble area. The WTRU may detect a (re) selection to an RNA that, for example does not belong and/or does not correspond to the current coverage ensemble area. The WTRU may detect execution of an RNA update procedure and/or or transmit an RNA update message to the network (e.g., base station). The WTRU may detect a (re) selection to a TA that does not belong and/or or ensemble does not correspond to the current coverage ensemble area. The WTRU may detect execution of a TA update procedure and/or or transmit a TA update message to the network (e.g., core network). The WTRU may detect a (re) selection to a PLMN that does not belong and/or or ensemble that does not correspond to the current coverage ensemble area.

The WTRU may discard the coverage ensemble configuration information, for example, when the coverage ensemble configuration information becomes outdated. An outdated indication may be derived, for example if WTRU changes it coverage area and/or does not (e.g., is not able to) acquire the updated coverage ensemble. Additionally, or alternatively, the configuration may include one or more explicit timers which, for example may result in the WTRU releasing the configuration if the one or more explicit timers expire. These timers may be refreshed, for example if the WTRU stays in the area associated with its current coverage ensemble. The coverage ensemble area may be defined in terms of RNA, TA, PLMN, and/or another suitable criterion.

The network may send an explicit indication to the WTRU to release its coverage ensemble configuration. The WTRU may release the coverage ensemble configuration, for example, if the WTRU goes out of RRC active state. Deployment ensembles may be provided to a WTRU. The cells/beam configurations and/or mobility configurations may be related to the deployment configuration.

A deployment ensemble (e.g., a deployment ensemble indication) may be part of the cell configuration. The cell configuration may be part of the conditional (re-)configuration associated with the PSCell and/or SCell. The cell configuration may be part of a conditional handover and/or conditional PSCell change/addition procedure. The deployment ensemble may be associated with any of the serving cell configurations and/or may be used for beam and/or cell level mobility procedures. New attributes may be added to the cell configuration. Attributes may define the TRPs where this cell is being transmitted, the locations of these TRPs in suitable global or local coordinate systems, and/or the beam coverage attributes for the beams being transmitted through these TRPs. The configuration may provide the information on SSB beams and/or CSI-RS beams. The attributes for beams may be in the form of azimuthal and/or elevation angle, for example with suitable reference directions. The reference directions may be taken from cardinal directions and/or can be indicated as part of the configuration itself. The range for the beams may be indicated as per beam attribute and/or a (e.g., single) value which may indicate the unobstructed range in view of the transmit power. Beam attributes may define the beam width in horizontal and/or vertical directions. A deployment may specify one (e.g., single) beam width attribute for horizontal and/or one for vertical which, for example may be (e.g., assumed to be) the same for one or more (e.g., all) of the configured beams. For the deployments with varying beam width sizes for example, the network may provide one value for a TRP. Delta values may (e.g., then) be provided for each beam. Beam width may be provided as part of the beam configuration, for example without any TRP and/or cell level indication. Coverage for each beam may be specified as an ellipsoid with (e.g., suitable) parametrization.

An ensemble indication may be provided as a (e.g., individual) configuration to WTRUs. For example, the coverage ensemble configuration may not be part of the cell configuration and/or the conditional (re-)configuration. The coverage ensemble may depend on the geographic deployment and/or coverage. Configuration and/or signaling may be provided by the network independent of the cell configuration and/or other conditional (re-)configurations.

The coverage ensemble configuration may be in the form of network nodes deployment and/or beam attributes. The coverage ensemble configuration may be in the form of on the ground detailed coverage, for example incorporating the topographic and/or terrain specific features. The coverage/deployment ensemble configuration may provide the linkage of indicated TRP locations and/or beam attributes to the cell identities and/or cell configurations.

A deployment/coverage ensemble indication may be transmitted by the network, for example in the form of broadcast signaling. This information may be broadcast by the network and/or the relevant devices may be pre-informed and/or may have prior knowledge on how to obtain and decode this information. The control information to locate the ensemble related broadcast information may be broadcast, for example through a special paging or a special downlink control information informing one or more (e.g., all) of the devices about the broadcast based ensemble information.

The ensemble indication may be treated as part of the system information. New system information block (SIB) may carry and/or convey deployment/coverage ensemble indication. The network may use periodic transmission of ensemble SIB to keep the WTRUs aware of the ensemble information. The WTRUs which, for example may be starting the relevant services where outage needs to be minimized, may send a (e.g., explicit) request to the network requesting the transmission of the ensemble SIB.

Radio measurements and/or non-radio measurements may be used (e.g., in an intelligent manner) to trigger certain events, for example combined with the provisioning of additional information from the network.

The WTRUs/devices may be equipped with interfaces from one or more of non-3GPP RATs, local sensors, and/or may be receive the environmental information and/or quantities from certain accumulation points. Usage of these quantities and/or their integration with the measurements over 3GPP standardized RATs may utilize a harmonized framework where, for example WTRUs may use the data from non-3GPP RATs alone or in combination with the data/measurements over 3GPP RATs. The examples herein provide a framework through which measurements and/or data quantities from non-3GPP RATs/sensors may be used for beam changes and/or cell change procedures.

The measurement procedures and/or the framework may be based upon measurement identities. A measurement identity may link a measurement object with a reporting configuration. A measurement object may include an object over which the WTRU may perform measurements, and/or may indicate one or more of time, frequency, bandwidth, and/or sub-carrier spacing parameters, for example relevant for the reference signal over which WTRU may perform measurements. A reporting configuration may provide one or more of the reporting criterion, the nature of the reporting whether periodic, an event trigger, and/or cell global identity reporting. For event triggered reporting for example, the reporting configuration may provide the triggering event and/or the suitable parameters relevant for that event.

Measurement objects may provide a pointer to the quantity configuration. A quantity configuration may provide the measurement filtering configuration which, for example may be applied to measurements prior to event evaluation and reporting.

A measurement identity may link a measurement object and a reporting configuration. The current measurement objects may belong to the same RAT, for example through which measurements are being configured or inter-RAT measurements defined over other 3GPP technologies. For non-radio-measurements from non-3GPP RATs for example, from local sensors and/or from other sources, there may be two solutions as herein.

The 3GPP measurement framework may be extended such that a measurement identity may provide a link of reporting configuration to a dummy measurement object which, for example may have (e.g., very) limited attributes. For non-radio-measurements for example, the reporting configuration may provide the information about the quantities with the events that need to be evaluated, reported, and/or used for decision making to perform one or more of the beam switching, cell switching, and/or broadly in conditional reconfiguration. The dummy measurement object may provide some parameters which, for example may be used to choose some aspects of the non-measurement data. They may provide a selection of parameters to be used when a non-3GPP interface and/or local sensor is known to provide information in multiple forms and formats. These measurement objects may also indicate (e.g., special) filtering, for example to be applied to these non-radio-measurement quantities through updated quantity configuration.

The 3GPP measurement framework may be extended to span the data coming from one or more of non-3GPP RATs, local sensors, and/or other sources. The 3GPP measurement framework may be used to define the measurement identities. The measurement identities may provide a pointer to the reporting configuration without any measurement object. The reporting configuration may be extended with the new events and/or relevant parameters which, for example may provide the information to handle the non-radio measurements (e.g., in a suitable manner).

For some of the non-radio measurements for example, measurement objects may provide the selection of the suitable parameters which are to be kept and/or used as part of non-radio measurement framework. The quantity configuration may provide additional post-processing and/or filtering coefficients which, for example may be applied to the non-radio measurements. Filtering and/or post-processing may be utilized for additional processing, for example to make these measurements quantities suitable for use in 3GPP procedures such as those used for mobility, conditional reconfiguration, and/or etc.

The reporting for non-radio measurements may be similar and/or the same as for radio measurements. Use of non-radio measurements to trigger the events may be similar and/or the same as for radio measurements. Use of these measurements and/or indicated events for the mobility procedures and/or conditional reconfigurations may be similar and/or the same as for radio measurements.

The network may share a suitable piece of deployment ensemble and/or the WTRUs may make intelligent decisions, trigger change of beams and cells, use local radio and/or non-radio measurements in the mobility procedures like beam recovery, perform conditional handover, perform conditional PSCell addition/change, and/or etc.

The reporting configuration may include the new non-measured-data based events where, for example, WTRUs may use the data from local sensors. These events may use the deployment attributes of cells and beams, for example from (e.g., both) serving (e.g., from primary cell group or secondary cell group) and/or neighboring cells/beams obtained from the deployment configuration. The events may be created based upon the sensor non-measured-data. These events may (e.g., then) be combined with the measurement data events, for example to validate the suitability of cells/beams for certain signal strength, etc. Composite events may be designed where conditions are specified for both non-measured-data-quantities (e.g., location/angle) and/or measurement quantities (e.g., SSB/CSI-RS RSRP/RSRQ/SINR). These composite events may be triggered when the suitable conditions from both groups are specified. The triggering of these composite events may (e.g., then) lead to the execution of the conditional (re-)configuration.

Conditional reconfiguration may have one or more (e.g., two) measurement identities. With the non-measured-data based events in combination with measured-data based events for example, the number of events may be increased. Joint measured and non-measured events may be created.

The WTRUs may evaluate events configured over a suitable combination of radio and/or non-radio measurements. The details on how these events are used in specific procedures is explained herein. Events on non-radio measurements are described herein.

The WTRU may consider the entering condition (e.g., when velocity becomes larger than a predetermined threshold) for a first event (e.g., event V1) to be satisfied when a condition, for example V1-1 as specified herein, is fulfilled. The WTRU may consider the leaving condition for the first event to be satisfied when a condition, for example V1-2 as specified herein, is fulfilled.

$$\begin{matrix}Inequality V1 - 1 ( Entering condition 1 ) & \\ Mv - Hys > Thresh 1 & \end{matrix}$$

$$\begin{matrix}Inequality V1 - 2 ( Leaving condition 1 ) & \\ Mv + Hys < Thresh 2 & \end{matrix}$$

The variables in the formula may be as follows: Mv is the WTRU velocity estimated by WTRU, for example through its local sensors not taking into account any offsets. Hys is the hysteresis parameter for this event (e.g., hysteresis as defined within configuration for this event). Thresh1 is the threshold for this event defined as a reference velocity within a configuration for this event and/or used as velocity threshold to enter this event. Thresh2 is the threshold for this event, for example defined as a reference velocity within a configuration for this event and/or used as velocity threshold to exit this event. Mv may be expressed in Km/hour. Hys may be expressed in the same unit as Mv. Thresh1 and Thresh2 may be expressed in the same unit as Mv. The definition of the first event (e.g., event V1) may also apply to CondEvent V1.

When device Rotation occurs for an amount larger than a pre-determined threshold, the WTRU may consider the entering condition for a second event (e.g., Event R1) to be satisfied when condition R1-1, for example as specified herein, is fulfilled. The WTRU may consider the leaving condition for the second event to be satisfied when condition R1-2, for example as specified herein, is fulfilled.

$$\begin{matrix}Inequality R1 - 1 ( Entering condition 1 ) & \\ Mr - Hys > Thresh 1 & \end{matrix}$$

$$\begin{matrix}Inequality R1 - 2 ( Leaving condition 1 ) & \\ Mr + Hys < Thresh 2 & \end{matrix}$$

The variables in the formula may be defined as follows: Mr is the WTRU rotation estimated by a WTRU, for example through its local sensors not taking into account any offsets, where the rotation estimation is over a duration not exceeding a duration Td configured as part of the configuration. Hys is the hysteresis parameter for this event (e.g., hysteresis as defined within configuration for this event). Thresh1 is the threshold for this event defined as an amount of reference rotation within a configuration for this event and/or used as rotation threshold to enter this event. Thresh2 is the threshold for this event defined as an amount of reference rotation within a configuration for this event and/or used as rotation threshold to exit this event. Mr may be expressed in degrees. Mr may be expressed in radians. Mr may be configured as part of the configuration. Hys may be expressed in the same unit as Mr. Thresh1 and/or Thresh2 may be expressed in the same unit as Mr. The definition of the second event (e.g., Event R1) may also apply to CondEvent R1.

When device orientation changes from serving orientation an amount larger than a predefined threshold for example, the WTRU may consider the entering condition for a third event (e.g., Event O1) to be satisfied when condition O1-1, (e.g., as specified herein), is fulfilled. The WTRU may consider the leaving condition for the third event to be satisfied when condition O1-2, for example as specified herein, is fulfilled.

$$\begin{matrix}Inequality O1 - 1 ( Entering condition 1 ) & \\ Mo - Hys > Thresh 1 & \end{matrix}$$

$$\begin{matrix}Inequality O1 - 2 ( Leaving condition 1 ) & \\ Mo + Hys < Thresh 2 & \end{matrix}$$

The variables in the formula may be defined as follows: Mr is the WTRU rotation estimated by a WTRU, for example through its local sensors not taking into account any offsets, where the rotation estimation is over a duration not exceeding a duration Td configured as part of the configuration. Hys is the hysteresis parameter for this event (e.g., hysteresis as defined within configuration for this event). Thresh1 is the threshold for this event defined as an amount of reference rotation within a configuration for this event and/or used as rotation threshold to enter this event. Thresh2 is the threshold for this event defined as an amount of reference rotation within a configuration for this event and/or used as rotation threshold to exit this event. Mr may expressed in degrees. In a compatible design, Mr may be expressed in radians. The unit for Mr may be configured as part of the configuration. Hys may be expressed in the same unit as Mr. Thresh1 and/or Thresh2 may be expressed in the same unit as Mr. The definition of the third event (e.g., Event O1) may also apply to CondEvent O1.

When device orientation and distance match the location of a given TRP within certain respective thresholds for example, the WTRU may consider the entering condition for a fourth event (e.g., Event OD1) to be satisfied when both condition OD1-1 and condition OD1-2 (e.g., as specified herein), are fulfilled. The WTRU may consider the leaving condition for the fourth event to be satisfied when condition OD1-3 and/or condition OD1-4 (e.g., as specified herein), is fulfilled.

### Inequality OD1-1 (Entering Condition 1) [Device has Absolute Orientation Matching the Target Cell Beam]

$$abs ( Ou - Thresh 1 ) < Hys 1$$

Inequality OD1-2 (Entering Condition 2) [Device is within a Suitable Distance from the Target TRP]

$$Ml + Hys 2 < Thresh 2$$

$$\begin{matrix}Inequality OD1 - 3 ( Leaving condition 1 ) & \\ abs ( Ou - Thresh 1 ) > Hys 1 & \end{matrix}$$

$$\begin{matrix}Inequality OD1 - 4 ( Leaving condition 2 ) & \\ Ml - Hys 2 > Thresh 2 & \end{matrix}$$

The variables in the formula may be defined as follows: MI is the WTRU location, represented by the distance between a WTRU and a reference location parameter for this event (e.g., reference location of candidate TRP for this event), for example not taking into account any offsets. Ou is the WTRU absolute orientation estimated by a WTRU, for example through its local sensors not taking into account any offsets. Hys1 is the hysteresis parameter for orientation condition used for this event. Thresh 1 is the threshold for this event defined as an amount of reference orientation within a configuration for this event and/or used as rotation threshold to enter this event. Thresh2 is the threshold for this event defined as a distance from a reference location configured in a configuration for this event. Ou may be expressed in degrees with respect to a configured measurement reference. Ou may be expressed in radians. The unit for Ou may be configured as part of the configuration. Hys1 may be expressed in the same unit as Ou. Thresh1 may be expressed in the same unit as Ou. MI may be expressed in meters. Hys2 may be expressed in the same unit as MI. Thresh2 may be expressed in the same unit as MI. The definition of the fourth event (e.g., Event OD1) may also apply to CondEvent OD1.

When device orientation and distance match the location of a given TRP better than the serving TRP according to the configured threshold(s) for example, the WTRU may consider the entering condition for a fifth event (e.g., Event OD2) to be satisfied when both condition OD2-1 and condition OD2-2 (e.g., as specified herein), are fulfilled. The WTRU may consider the leaving condition for the fifth event to be satisfied when condition OD2-3 and/or condition OD2-4 (e.g., as specified herein), is fulfilled.

Inequality OD2-1 (Entering Condition 1) [Device has Absolute Orientation Aligning Better the Target Cell TRP than the Serving Cell Orientation]

$$abs ( Ou - On ) - Hys 1 < abs ( Ou - O p )$$

Inequality OD2-2 (Entering Condition 2) [Device is within a Suitable Distance from the Target TRP]

$$D n - H y s 2 < D$$

$$\begin{matrix}Inequality OD2 - 3 ( Leaving condition 1 ) & \\ abs ( Ou - On ) + Hys 1 > abs ( Ou - O p ) & \end{matrix}$$

$$\begin{matrix}Inequality OD2 - 4 ( Leaving condition 2 ) & \\ Dn + Hys 2 > D p & \end{matrix}$$

The variables in the formula may be defined as follows: Ou is the WTRU reference orientation (e.g., in absolute units) estimated by a WTRU, for example through its local sensors not taking into account any offsets. Op is the orientation of the serving TRP (e.g., in absolute units) from the WTRU as estimated by WTRU using the location of the serving TRP received in configuration. On is the orientation of the neighbour TRP (e.g., in absolute units) from the WTRU as estimated by WTRU using the location of the neighbour TRP received in configuration. Hys1 is the hysteresis parameter for an orientation condition used for this event. Dp is the distance between WTRU location and the location of the serving TRP where, for example the location of the serving TRP is part of the configuration. Dn is the distance between WTRU location and the location of the neighbour TRP where, for example the location of the neighbour TRP is part of the configuration. Hys2 is the hysteresis parameter for distance condition used for this event. Ou may be expressed in degrees with respect to a configured measurement reference. Ou may be expressed in radians. The unit for Ou may be configured as part of the configuration. Op. On and/or Hys1 may be expressed in the same unit as Ou. Dn may be expressed in meters. Dp and/or Hys2 may be expressed in the same unit as Dn. The definition of the fifth event (e.g., Event OD2) may also apply to CondEvent OD2.

When a device crosses out the boundary of a specific zone in the coverage ensemble, the WTRU may consider the entering condition for a sixth event (e.g., Event CM1) to be satisfied when condition CM1-1 (e.g., as specified herein), is fulfilled. The WTRU may consider the leaving condition for the sixth event to be satisfied when condition CM1-2 (e.g., as specified herein), is fulfilled.

### Inequality CM1-1 (Entering Condition) [Device Crosses a Boundary in the Coverage Ensemble]

$$Ml 1 - Hys > Thresh 1$$

$$\begin{matrix}Inequality CM1 - 2 ( Leaving condition ) & \\ Ml 1 + Hys < Thresh 1 & \end{matrix}$$

The variables in the formula may be defined as follows: MI1 is the WTRU location, represented by the distance between WTRU and a reference location parameter for this event, for example not taking into account any offsets. Hys is the hysteresis parameter for this event (e.g., hysteresis as defined within reportConfigNR for this event). Thresh1 is the threshold for this event defined as a distance from a reference location (e.g., serving TRP) to a boundary of the coverage ensemble. A WTRU may derive Thresh1 from the coverage ensemble, for example using one or more of the information of its current location and/or the serving TRP location and the boundary definition according to the configuration. A boundary definition may correspond to the coverage of one or more of a RNA, TA, PLMN and/or TRP coverage. A configuration may provide the information whether Thresh1 is LOS distance (e.g., in that case, Thresh1 is the distance of the coverage boundary on the line joining the serving TRP and WTRU) or a different calculation is to be used. MI1 may be expressed in meters. Hys may be expressed in the same unit as MI1. Thresh1 may be expressed in the same unit as MI1. The definition of the sixth event (e.g., Event CM1) may also apply to CondEvent CM1.

When a device enters a specific zone in the coverage ensemble, the WTRU may consider the entering condition for a seventh event (e.g., Event CM2) to be satisfied when condition CM2-1 (e.g., as specified herein), is fulfilled. The WTRU may consider the leaving condition for the seventh event to be satisfied when condition CM2-2 (e.g., as specified herein), is fulfilled.

Inequality CM2-1 (Entering Condition) [Device Crosses into a Specific Zone in the Coverage Ensemble]

$$Ml 1 - Hys < Thresh 1$$

$$\begin{matrix}Inequality CM2 - 2 ( Leaving condition ) & \\ Ml 1 + Hys > Thresh 1 & \end{matrix}$$

The variables in the formula may be defined as follows: MI1 is the WTRU location, represented by the distance between WTRU and a reference location parameter for this event not taking into account any offsets. The reference location may be attributed to the specific zone to which this event is associated. Hys is the hysteresis parameter for this event (e.g., hysteresis as defined within reportConfigNR for this event). Thresh1 is the threshold for this event defined as a distance from a reference location (e.g., reference gNB/TRP location of the reference zone) to a boundary of the coverage ensemble. A WTRU may derive Thresh1 from the coverage ensemble, for example using the information of its current location, the reference gNB/TRP location and/or the boundary definition according to the configuration. A boundary definition may correspond to the coverage of one or more of a RNA, TA, PLMN, and/or gNB/TRP coverage. A configuration may provide the information whether Thresh1 is LOS distance (e.g., in that case, Thresh1 is the distance of the coverage boundary on the line joining the reference TRP and WTRU) or a different calculation is to be used. MI1 may be expressed in meters. Hys may be expressed in the same unit as MI1. Thresh1 may be expressed in the same unit as MI1. The definition of the seventh event (e.g., Event CM2) may also apply to CondEvent CM2.

When a device enters a specific zone in the coverage ensemble and/or the reference cell in the zone becomes better than a threshold, the WTRU may consider the entering condition for an eighth event (e.g., Joint Event J1-CM2 and A4) to be satisfied when, for example condition J1-1 and/or condition J1-2 (e.g., as specified herein), are fulfilled. The WTRU may consider the leaving condition for the eighth event to be satisfied when condition J1-3 and/or J1-4 (e.g., as specified herein), is fulfilled.

Inequality J1-1 (Entering Condition) [Device Crosses into a Specific Zone in the Coverage Ensemble]

$$Ml - Hys 1 < Thresh 1$$

$$\begin{matrix}Inequality J1 - 2 ( Entering condition ) & \\ Mn + Ofn + Ocn - Hys 2 > Thresh 2 & \end{matrix}$$

$$\begin{matrix}Inequality J1 - 3 ( Leaving condition ) & \\ Ml + Hys 1 > Thresh 1 & \end{matrix}$$

$$\begin{matrix}Inequality J1 - 4 ( Leaving condition ) & \\ Mn + Ofn + Ocn + Hys 2 < Thresh 2 & \end{matrix}$$

The variables in the formula may be defined as follows: MI is the WTRU location, represented by the distance between WTRU and a reference location parameter for this event, for example not taking into account any offsets. The reference location is attributed to the specific zone to which this event is associated. Hys1 is the hysteresis parameter for this event (e.g., hysteresis as defined within reportConfigNR for this event), for example to be used in location conditions. Thresh1 is the threshold for this event defined as a distance from a reference location (e.g., reference gNB/TRP location of the reference zone) to a boundary of the coverage ensemble. A WTRU may derive Thresh1 from the coverage ensemble using one or more of the information of its current location, and/or the reference gNB/TRP location and/or the boundary definition according to the configuration. A boundary definition may correspond to the coverage of one or more of a RNA, TA, PLMN, and/or gNB/TRP coverage. A configuration may provide the information whether Thresh1 is LOS distance (e.g., in that case, Thresh1 is the distance of the coverage boundary on the line joining the reference TRP and WTRU) or a different calculation is to be used. Mn is the measurement result of the neighbouring cell, for example not taking into account any offsets. Ofn is the measurement object specific offset of the neighbour cell (e.g., offsetMO as defined within measObjectNR corresponding to the neighbour cell). Ocn is the measurement object specific offset of the neighbour cell (e.g., cellIndividualOffset as defined within measObjectNR corresponding to the neighbour cell), and/or set to zero, for example if not configured for the neighbour cell. Hys2 is the hysteresis parameter for this event (e.g., hysteresis as defined within reportConfigNR for this event), for example to be used in cell measurement conditions. Thresh2 is the threshold parameter for this event (e.g., a4-Threshold as defined within reportConfigNR for this event). MI may be expressed in meters. Hys1 may be expressed in the same unit as MI1. Thresh1 may be expressed in the same unit as MI1. Mn may be expressed in dBm in case of RSRP, or in dB, for example in case of RSRQ and RS-SINR. Ofn, Ocn, Hys2 may be expressed in dB. Thresh2 may be expressed in the same unit as Mn. The definition of the eighth event (e.g., Event J1) may also apply to CondEvent J1.

When a device orientation and distance better match the location of a given TRP than the serving TRP according to the configured thresholds for example, the WTRU may consider the entering condition for a ninth event (e.g., Joint Event J2-OD2 and A4) to be satisfied when conditions J2-1, J2-2, and/or J2-3 (e.g., as specified herein), are fulfilled. The WTRU may consider the leaving condition for the ninth event to be satisfied when any of the conditions J2-4, J2-5, and/or J2-6 (e.g., as specified herein), is fulfilled.

### Inequality J2-1 (Entering Condition 1) [Device has Absolute Orientation Aligning Better the Target Cell TRP Than the Serving Cell Orientation]

$$abs ( Ou - On ) - Hys 1 < abs ( Ou - O p )$$

Inequality J2-2 (Entering Condition 2) [Device is within a Suitable Distance from the Target TRP]

$$Dn - Hys 2 < Dp$$

$$\begin{matrix}Inequality J2 - 3 ( Entering condition ) & \\ Mn + Ofn + Ocn - Hys 3 > Thresh 3 & \end{matrix}$$

$$\begin{matrix}Inequality J2 - 4 ( Leaving condition 1 ) & \\ abs ( Ou - On ) + Hys 1 > abs ( Ou - Op ) & \end{matrix}$$

$$\begin{matrix}Inequality J2 - 5 ( Leaving condition 2 ) & \\ Dn + Hys 2 > Dp & \end{matrix}$$

$$\begin{matrix}Inequality J2 - 6 ( Leaving condition 3 ) & \\ Mn + Ofn + Ocn + Hys 3 < Thresh 3 & \end{matrix}$$

The variables in the formula may be defined as follows: Ou is the WTRU reference orientation (e.g., in absolute units) estimated by WTRU, for example through its local sensors not taking into account any offsets. Op is the orientation of the serving TRP (e.g., in absolute units) from the WTRU as estimated by WTRU using the location of the serving TRP received in configuration. On is the orientation of the neighbour TRP (e.g., in absolute units) from the WTRU as estimated by WTRU using the location of the neighbour TRP received in configuration. Hys1 is the hysteresis parameter for an orientation condition, for example used for this event. Dp is the distance between WTRU location and the location of the serving TRP where, for example the location of the serving TRP is part of the configuration. Dn is the distance between WTRU location and the location of the neighbour TRP where, for example the location of the neighbour TRP is part of the configuration. Hys2 is the hysteresis parameter for distance condition used for this event. Mn is the measurement result of the neighbouring cell, for example not taking into account any offsets. Ofn is the measurement object specific offset of the neighbour cell (e.g., offsetMO as defined within measObjectNR corresponding to the neighbour cell). Ocn is the measurement object specific offset of the neighbour cell (e.g., cellIndividualOffset as defined within measObjectNR corresponding to the neighbour cell), and/or set to zero, for example if not configured for the neighbour cell. Hys3 is the hysteresis parameter for this event (e.g., hysteresis as defined within reportConfigNR for this event) to be used in cell measurement conditions. Thresh3 is the threshold parameter for this event (e.g., a4-Threshold as defined within reportConfigNR for this event). Ou may be expressed in degrees with respect to a configured measurement reference. Ou may be expressed in radians. The unit for Ou may be configured as part of the configuration. Op, On and/or Hys1 may be expressed in the same unit as Ou. Dn may be expressed in meters. Dp and/or Hys2 may be expressed in the same unit as Dn. Mn may be expressed in dBm (e.g., in case of RSRP), or in dB (e.g., in case of RSRQ and/or RS-SINR). Ofn, Ocn, and/or Hys3 may be expressed in dB. Thresh3 may be expressed in the same unit as Mn. The definition of the ninth event (e.g., Event J2) may also apply to CondEvent J2.

When a device enters a specific zone in the coverage ensemble and the reference cell in this zone becomes better than SpCell for example, the WTRU may consider the entering condition for a tenth event (e.g., Joint Event J3—CM2 and A3) to be satisfied when condition J3-1 and/or condition J3-2 (e.g., as specified herein), are fulfilled. The WTRU may consider the leaving condition for the tenth event to be satisfied when condition J3-3 or J3-4 (e.g., as specified herein), is fulfilled.

Inequality J3-1 (Entering Condition) [Device Crosses into a Specific Zone in the Coverage Ensemble]

$$Ml - Hys 1 < Thresh 1$$

$$\begin{matrix}Inequality J3 - 2 ( Entering condition ) & \\ Mn + Ofn + Ocn - Hys 2 > Mp + Ofp + Ocp + Off & \end{matrix}$$

$$\begin{matrix}Inequality J3 - 3 ( Leaving condition ) & \\ Ml + Hys 1 > Thresh 1 & \end{matrix}$$

$$\begin{matrix}Inequality J3 - 4 ( Leaving condition ) & \\ Mn + Ofn + Ocn + Hys 2 < Mp + Ofp + Ocp + Off & \end{matrix}$$

The variables in the formula may be defined as follows: MI is the WTRU location, represented by the distance between WTRU and a reference location parameter for this event, for example not taking into account any offsets. The reference location is attributed to the specific zone to which this event is associated. Hys1 is the hysteresis parameter for this event (e.g., hysteresis as defined within reportConfigNR for this event) to be used in location conditions. Thresh1 is the threshold for this event defined as a distance from a reference location (e.g., reference gNB/TRP location of the reference zone) to a boundary of the coverage ensemble. A WTRU may derive Thresh1 from the coverage ensemble, for example using the information of its current location, and/or the reference gNB/TRP location and the boundary definition according to the configuration. A boundary definition may correspond to the coverage of one or more of a RNA, TA, PLMN, and/or gNB/TRP coverage. A configuration may provide the information whether Thresh1 is LOS distance (e.g., in that case, Thresh1 is the distance of the coverage boundary on the line joining the reference TRP and WTRU) or a different calculation is to be used. Mn is the measurement result of the neighbouring cell, for example not taking into account any offsets. Ofn is the measurement object specific offset of the neighbour cell (e.g., offsetMO as defined within measObjectNR corresponding to the neighbour cell). Ocn is the measurement object specific offset of the neighbour cell (e.g., cellIndividualOffset as defined within measObjectNR corresponding to the neighbour cell), and/or set to zero, for example if not configured for the neighbour cell. Mp is the measurement result of the SpCell, for example not taking into account any offsets. Ofp is the measurement object specific offset of the SpCell (e.g., offsetMO as defined within measObjectNR corresponding to the SpCell). Ocp is the cell specific offset of the SpCell (e.g., cellIndividualOffset as defined within measObjectNR corresponding to the SpCell), and/or is set to zero, for example if not configured for the SpCell. Off is the offset parameter for this event (e.g., a3-Offset as defined within reportConfigNR for this event). Hys2 is the hysteresis parameter for this event (e.g., hysteresis as defined within reportConfigNR for this event) to be used in cell measurement conditions. MI may be expressed in meters. Hys1 may be expressed in the same unit as MI1. Thresh1 may be expressed in the same unit as MI1. Mn and/or Mp may be expressed in dBm (e.g., in case of RSRP), or in dB (e.g., in case of RSRQ and/or RS-SINR). Ofn, Ocn, Ofp, Ocp, Hys2, and/or Off may be expressed in dB. The definition of the tenth event (e.g., Event J3) may also apply to CondEvent J3.

When a device orientation and distance better match the location of a given TRP than the serving TRP according to the configured thresholds and/or the reference cell in this zone becomes better than SpCell for example, the WTRU may consider the entering condition for an eleventh event (e.g., Joint Event 4—OD2 and A3) to be satisfied when conditions J4-1, J4-2, and/or J4-3 (e.g., as specified herein), are fulfilled. The WTRU may consider the leaving condition for the eleventh event to be satisfied when one or more (e.g., any) of the conditions J4-4, or J4-5, and/or J4-6 (e.g., as specified herein), is fulfilled.

### Inequality J4-1 (Entering Condition 1) [Device has Absolute Orientation Aligning Better the Target Cell TRP Than the Serving Cell Orientation]

$$abs ( Ou - O n ) - Hys 1 < abs ( Ou - O p )$$

Inequality J4-2 (Entering Condition 2) [Device is within a Suitable Distance from the Target TRP]

$$Dn - Hys 2 < Dp$$

$$\begin{matrix}Inequality J4 - 3 ( Entering condition ) & \\ Mn + Ofn + Ocn - Hys 3 > Mp + Ofp + Ocp + Off & \end{matrix}$$

$$\begin{matrix}Inequality J4 - 4 ( Leaving condition 1 ) & \\ abs ( Ou - On ) + Hys 1 > abs ( Ou - Op ) & \end{matrix}$$

$$\begin{matrix}Inequality J4 - 5 ( Leaving condition 2 ) & \\ Dn + Hys 2 > Dp & \end{matrix}$$

$$\begin{matrix}Inequality J4 - 6 ( Leaving condition 3 ) & \\ Mn + Ofn + Ocn + Hys 3 < Mp + Ofp + Ocp + Off & \end{matrix}$$

The variables in the formula may be defined as follows: Ou is the WTRU reference orientation (e.g., in absolute units) estimated by a WTRU, for example through its local sensors not taking into account any offsets. Op is the orientation of the serving TRP (e.g., in absolute units) from the WTRU as estimated by the WTRU, for example using the location of the serving TRP received in configuration. On is the orientation of the neighbour TRP (e.g., in absolute units) from the WTRU as estimated by the WTRU, for example using the location of the neighbour TRP received in configuration. Hys1 is the hysteresis parameter for an orientation condition, for example used for this event. Dp is the distance between a WTRU location and the location of the serving TRP where, for example the location of the serving TRP is part of the configuration. Dn is the distance between a WTRU location and the location of the neighbour TRP where, for example the location of the neighbour TRP is part of the configuration. Hys2 is the hysteresis parameter for a distance condition, for example used for this event. Mn is the measurement result of the neighbouring cell, for example not taking into account any offsets. Ofn is the measurement object specific offset of the neighbour cell (e.g., offsetMO as defined within measObjectNR corresponding to the neighbour cell). Ocn is the measurement object specific offset of the neighbour cell (e.g., cellIndividualOffset as defined within measObjectNR corresponding to the neighbour cell), and/or set to zero, for example if not configured for the neighbour cell. Mp is the measurement result of the SpCell, for example not taking into account any offsets. Ofp is the measurement object specific offset of the SpCell (e.g., offsetMO as defined within measObjectNR corresponding to the SpCell). Ocp is the cell specific offset of the SpCell (e.g., cellIndividualOffset as defined within measObjectNR corresponding to the SpCell), and/or is set to zero, for example if not configured for the SpCell. Off is the offset parameter for this event (e.g., a3-Offset as defined within reportConfigNR for this event). Thresh3 is the threshold parameter for this event (e.g., a4-Threshold as defined within reportConfigNR for this event). Ou may be expressed in degrees with respect to a configured measurement reference. Ou may be expressed in radians. The unit for Ou may be configured as part of the configuration. Op, On and/or Hys1 may be expressed in the same unit as Ou. Dn may be expressed in meters. Dp and/or Hys2 may be expressed in the same unit as Dn. Mn and/or Mp may be expressed in dBm (e.g., in case of RSRP), or in dB (e.g., in case of RSRQ and/or RS-SINR). Ofn, Ocn, Ofp, Ocp, Hys3, and/or Of may be expressed in dB. The definition of the eleventh event (e.g., Event J4) may also apply to CondEvent J4.

Example events disclosed herein may combine the measurement quantities over radio measurements and/or non-radio measurements to (e.g., suitable) events which, for example may be used to achieve zero outage in mobility by triggering conditional (re-)configurations (e.g., beam failure recovery, conditional handover, conditional PSCell change/addition, and/or etc). These examples may be used to create additional events jointly over radio measurement and/or non-radio measurement quantities which, for example may identify the target scenario (e.g., in a very precise manner) and/or choose the most suitable beam/cell/TRP/gNB (e.g., in a fast manner thanks to these combinations).

In the examples of joint events, event A3 and A4 may be combined with non-radio measurement quantities combing, for example one or more of orientation, distance, and/or zone entrance. A5 can be combined with non-radio measurement quantities combing, for example one or more of orientation, distance, and/or zone entrance.

The examples of joint events J1, J2, J3, and/or J4 may be combined with a speed/velocity condition(s) (e.g., as used in event V1), for example to segregate high speed and low speed scenarios and use suitable beams/cells/TRPs accordingly.

For devices with rotation (e.g., rotation only) concerns, event R1 and/or event O1 may be combined with classic measurement quantity events (e.g., A3, A4, and/or A5) etc., for example to create rotation focused conditional events which may then trigger suitable (re-)configurations.

If measurement objects are defined for non-radio measurements for example, the current 3GPP reporting framework may be applicable to the newly introduced non-radio measurements. According to the reporting configuration attributes whether periodic or event triggered for example, a WTRU may provide the non-radio measurements (e.g., suitably) filtered according to the quantity configuration and/or provide this report to the network, for example with the indication of measurement identity which serves as the reference for the reporting.

For the alternative design where measurement identities may be configured by the network without a measurement object for example, the reporting for non-radio measurements may be based upon the reporting configuration. The post-processing and/or filtering over non-radio measurements may (e.g., either) be not applied and/or defined a-priori without a quantity configuration.

CPA/CPC (e.g., proactive CPA/CPC) may be performed based on Non-Radio Measurements. In a conditional PSCell change (CPC) procedure, a WTRU may be provided with the configuration of candidate PSCells with CPC execution conditions. Upon receiving the configuration for example, a WTRU may start evaluating the configured execution conditions. When the execution condition for a candidate PSCell is satisfied for example, a WTRU may perform the PSCell change procedure.

The CPC procedure may be initiated by the master node running the primary cell group and/or by the secondary node running the secondary cell group. Additionally, or alternatively, when initiated by the secondary node for example, a CPC procedure may or may not involve a master node and/or the signaling may be sent through the direct signaling bearer from a secondary node to the WTRU and/or as RRC message through the master node. A (e.g., updated) CPC configuration, for example with the deployment/coverage ensembles, may be provided to a WTRU. The WTRU may use non-radio measurements data in combination with radio measurements data to trigger the proactive CPA/CPC procedures. When a gNB is configuring the WTRU, the gNB may be the master gNB or the secondary gNB. Assistance information from a WTRU may be provided to the master gNB and/or the secondary gNB as part of the (e.g., normal) RRC setup. The master gNB and/or the secondary gNB may request assistance information from the WTRU, for example, to help the proactive CPC configuration.

Proactive CPC may enable predictive mobility. As cellular networks are planned networks, the network may have precise knowledge of its deployment of cells, and/or the beams within those cells. A network may not know how a specific WTRU may move from one cell/beam to another cell/beam. A WTRU may have no information of network deployment, for example in terms of cells, beams, and/or the geographic areas where these cells/beams are active. A WTRU may be equipped with (e.g., many) local sensors and/or may have additional interfaces and/or connections to other RATs/devices, for example around with which it may track its movements and/or may determine its new geographic coordinates and/or orientation (e.g., in a very fast and accurate manner).

The knowledge of network deployment of cells/beams may be combined with the ability of a WTRU to track its movements and/or determine updated geographic location/position and/or orientation. This combined knowledge allows a WTRU to choose a suitable PSCell (e.g., and its relevant beam) for CPC, for example without any delay/latency having provided with suitable configuration from the network. The network may share a (e.g., suitable finite) piece of its deployment relevant to a WTRU, for example based upon assistance information received from this WTRU. The network may use additional or alternative information, for example one or more of WTRU profile, past history on data/application usage, past history on its movement, and/or the network data gathered over other WTRUs. The shared piece of network deployment may include neighboring cells and/or relevant beams provided with a mapping of these (e.g., cell, beam) pairs to suitable geographic coordinates. The configuration may include the execution conditions to perform conditional PSCell change to one of the configured (e.g., cell, beam) pairs. In case of degradation over the PSCell link quality for example, a WTRU may use the information from local sensors and/or interfaces to extract its current geographic coordinates and/or orientation. With these parameters for example, a WTRU may determine the suitable PSCell candidate (e.g., cell, beam) pair from the network provided configuration. The configuration parameters may provide the quality criterion and/or execution conditions for the candidate (e.g., cell, beam) pair. The configuration may indicate whether RACH is required for the PSCell change. In case of RACH required to change the PSCell for example, RACH configuration with the candidate PSCell (e.g., cell, beam) pair may be provided. If the execution conditions are fulfilled for a target PSCell (e.g., cell, beam), a WTRU may initiate a conditional PSCell change to the candidate (e.g., cell, beam) pair. The deterministic derivation of suitable candidate (e.g., cell, beam) pairs with the updated geographic coordinates may lead to WTRU mobility management with seamless PSCell change and/or minimal interruptions.

The assistance information from WTRU may be (e.g., broadly) categorized in two or more groups. Groups may include radio signal measurement based data and/or non-radio signal measurement-based data. Radio signal measurement based data may be referred to herein as measurement based data, and/or non-radio-signal measurement based data may be referred to herein as non-measurement-based data. A first group may include some or all the information that can be one or more of estimated, measured, and/or determined, for example with and/or without post-processing over the signals received from the radio interface where mobility is being considered. The first group may be termed as measurement-based (e.g., radio measurement-based) data. This may include one or more of receiving, measuring, and/or processing the reference signals on the physical layer, MAC information elements, RRC messages received from the network, and/or the information received at higher layers. The corresponding measurements quantities may be in the form of one or more of RSRP, RSSI, RSRQ, SNR, and/or SINR.

The second group may include some or all of the information that is not extracted from the network signaling. This group may be termed as non-measurement-based data. One sub-group in non-measurement-based data may include one or more of the WTRU capability and/or implementation details covering its antenna panels, respective field-of-views for those panels, transceiver and/or power characteristics, switching delays, simultaneous operation for the panels, and/or etc. The second sub-group in non-measurement-based data may include some or all of the information extracted and/or measured through local sensors and/or interfaces, for example other than the radio interface where mobility is being considered (e.g., the WTRU geographic parameters, the WTRU location information such as absolute position, relative positions to objects or other geographical markers, and/or reference location of serving or neighboring cell/TRP(s)). Examples of local sensors may include positioning sensors, gyroscopes, accelerometers, speed monitoring sensors, and/or etc. The interfaces other than the considered radio interface may be wired interfaces like ethernet, wireless interfaces like Bluetooth, WiFi, and/or any other proprietary wired or wireless interfaces. Yet another sub-group in non-measurement-based data may include the mobility metrics and/or configurational triggers. Examples of mobility metrics may be the speed (e.g., translational and/or rotational), direction (e.g., translational or/and rotational), velocity, trajectory, or/and history of mobility. The (e.g., relevant) configurational triggers for mobility management and/or for providing the suitable configuration may come from situational and/or contextual information (e.g., a vehicular device and/or the devices inside), for example starting its trajectory to a destination where (e.g., both) the start and/or the trajectory may be important from the configuration perspective. Another example may be the start of a network game from an AR/VR device, for example including a user profile (e.g., which may incorporate and/or provide the user behavior in terms of rotations during the game). Parameters may be updated by a WTRU and/or receiving BFR configuration from the gNB. The gNB may update the BFR configuration upon receiving the updated assistance information from a WTRU and/or other factors.

Overlapping may occur (e.g., similar information may be available in a measurement-based and/or a non-measurement-based group). One example is the positioning, where the network may provide some positioning information (e.g., measurement-based) while, for example the WTRU may be equipped with a local positioning sensor (e.g., which may extract the positioning information from any of the satellite systems). In such a case, one or the other may be used, or both information sets can be combined, for example to achieve better accuracy, granularity and/or information quality.

The systems and methods proposed herein may target conditional PSCell change (e.g., in a predictable manner), for example combining the network shared deployment of cells/beams and/or WTRU knowledge of its whereabouts. The key steps of this approach are summarized herein.

A WTRU may provide assistance information regarding its position/location/panels/FoV/Application-QoS to the gNb. This assistance information may incorporate and/or streamline the (e.g., potential) information originating from (e.g., advanced) sensors which, for example may be used by WTRU and/or provided to the gNB. Examples of such information may include the information generated through one or more of positioning sensors, gyroscopes, and/or accelerometers. A WTRU may update its assistance information, for example for certain parameters under certain conditions.

The gNB may provide the (e.g., proactive) conditional PSCell change configuration, for example in response to the WTRU assistance information. The configuration may be based on the network deployment of one or more of cells, TRPs, beams, and/or WTRU provided assistance information. The configuration preparation may take into account any historical data about one or more or WTRU parameters, applications usage, WTRU subscription status, and/or etc. The configuration preparation may use the artificial intelligence and/or machine learning algorithms to prepare the configuration suitable to WTRU in a predictive manner, for example using the network and WTRU data.

The (e.g., proactive conditional) PSCell change configuration may include a set of candidate cells. For each cell, relevant beam indices may be provided. For each (e.g., cell and/or beam) pair, the mapping of the pair to suitable active zones (e.g., position/location, angular span, and/or WTRU panel) may be provided where, for example this cell/beam pair may be used to access that cell. The execution conditions may be provided as part of the configuration for each (e.g., cell and/or beam) pair. When multiple pairs are indicated for a given location and angular span for example, the priority for (e.g., cell, beam) pair may be provided as part of the configuration. For each candidate (e.g., cell, beam) pair requiring RACH as part of PSCell change procedure for example, the configuration may provide suitable RACH preambles and/or other RACH configuration parameters.

After a mobility event (e.g., resulting from device mobility and/or mobility in the environment) leading to compromised link quality of serving PSCell for example, the WTRU may extract the information (e.g., from its local sensors). A WTRU may combine suitable information elements from radio measurements and/or non-radio measurements. From its estimated geographic coordinates and/or orientation for example, a WTRU may derive the highest priority (e.g., cell, beam) pair as PSCell candidate from the network configured mapping (e.g., which are mapped to its estimated geographical coordinates).

A WTRU may evaluate the execution condition for the determined (e.g., cell, beam) pair as per the network provided configuration and/or if fulfilled for example, perform conditional PSCell change to the determined (e.g., cell, beam) pair. If a configuration indicates use of RACH for example, a WTRU may extract the provided RACH configuration and/or transmit RACH to the target PSCell (e.g., using the derived RACH parameters).

Although the WTRU provided assistance information may help the network customize the proactive CPC configuration, the assistance information may not be necessary (e.g., mandatory). The network may prepare and/or provide the suitable proactive CPC configuration to the WTRUs, for example (e.g., primarily) based on its deployment knowledge. A configuration may be refined, for example using one or more of the terrain knowledge, the network statistics on WTRU mobility, WTRU profiling patterns, and/or etc.

The association of CPC candidates to the geographic coordinates including position/location/orientation may be provided as part of the CPC configuration. The deployment and/or coverage ensemble may be provided by the network, for example as a separate configuration. The deployment/coverage ensemble may be broadcast by the network, for example as part of the system information. Definitions of deployment and coverage ensembles, WTRU processing, and different signaling mechanisms are provided herein.

The network may provide information about deployment/coverage ensemble to the WTRUs. The network may provide the conditional configurations relating to the primary cell (handover procedure) and relating to the PSCell (conditional PSCell change procedure). The WTRUs use the ensemble information in combination with any configured conditional configuration procedure.

The coverage ensemble may be defined at different (e.g., suitable) granularities. The granularity of the coverage ensemble may be part of the coverage ensemble configuration. The coverage ensemble may be defined at cell level and/or the information of geographic coverage from different gNBs/TRPs may be indicated to WTRUs with (e.g., suitable) signaling. The cell level coverage may be useful for different hand-over and/or cell change procedures. The coverage ensemble granularity may be reflected in the form of zones which, for example may represent the level of granularity. A zone may be attributed to (e.g., each) RNA, TA, and/or PLMN. For cell level procedures for example, the coverage ensemble zones may have the cell level granularity. For beam level procedures where for example a WTRU may need to track, maintain, and/or switch beams for example, the coverage ensemble granularity may be at beam level, and/or the zones (e.g., in such a coverage ensemble be attributed to different beams). For cell level procedures, the knowledge of beam level zones may be helpful. If the transmission/reception is happening through beams within a given cell for example (e.g., the default mode of operation for high frequency systems), the WTRU may receive and/or transmit through the suitable beam of the target cell (e.g., to be able to communicate effectively).

The zones in the coverage ensemble may be indicative of the geographic area which, for example may correspond to a set of reference signals. For beam level zones for example, each zone may indicate the coverage area for an SSB beam. Each zone may indicate the coverage area for an SSB beam and/or a CSI-RS beam where, for example SSB/CSI-RS beam may be the coverage for the corresponding SSB/CSI-RS signals. The zone may indicate the area where the cell has sufficient coverage. The cell level zone may group one or more (e.g., all) of the SSB/CSI-RS zones associated with a given cell and/or may represent the area where (e.g., any of) the SSB/CSI-RS signals for this cell may be received with a known/configured quality. In the same way for example, the zone representation may be extended to larger granularities for one or more of RNA, TA, and/or PLMN based coverage zones.

Each zone may have an identity. The identity may be indicated (e.g., explicitly) as part of the zone configuration. The zone identity may include a deterministic combination of (e.g., the certain) parameters, for example as a function of zone granularity. These identities may be modulated with (e.g., some) configuration parameters. A beam level zone identity may be a combination of cell identity and beam identity (e.g., SSB and/or CSI-RS). The cell level zone identity may be the cell identity and/or a deterministic modification of the cell identity, for example by combining with (e.g., some) other parameters. The same may be used for zones mapped to represent the coverage for one or more of RNA, TA, PLMN, and/or etc.

A WTRU may derive the information from radio measurements and/or non-radio measurements, for example to aid in mobility procedures. The information derived from non-radio measurements including geographic coordinates and/or orientation may allow the WTRU derive its current zone. A WTRU may be configured by the network with a measurement configuration wherein, for example the conditional events, event CM1 and/or event CM2 (e.g., as detailed herein), may be configured. When the relevant conditions for these events are fulfilled for example, the WTRU may determine the change of its current zone. The WTRU may determine its new zone, that for example may allow the WTRU to perform one or more of deriving the suitable configuration and/or candidate from the coverage ensemble corresponding to this updated zone, validating the candidate configuration from radio signal measurements, and/or executing the conditional CPC to the successful candidate. The same may be achieved by network configuring the WTRU with events which, for example may have conditions composite over radio and/or non-radio measurement quantities. These events may be defined as J1, J2, J3, and/or J4 as herein.

A WTRU may have limited discovery of neighboring cells/gNBs around it, for example due to one or more of ultra-massive MIMO beam deployments, higher mobility, special conditions in terms of nature of the objects placements and blocking on the ground, limited number of antennas, antenna panels, and/or transceivers or stringent requirements on power consumption. This may result in limited or no neighboring cells being discovered and reported by a WTRU to the network. This may limit the configurations from the network and/or mobility aggravated by rotation may land a WTRU in the angular coverage of a beam of new gNB that, for example the WTRU was not able to discover and report to the network. The most suitable (e.g., cell and/or beam) may change (e.g., much) faster for the future deployments of ultra-massive MIMO beams and/or if each such change requires network configuration and exchanges with the network, the resulting overhead may be exorbitant. The proposed proactive CPC may provide a mechanism to avoid frequent and/r larger interruptions for such scenarios.

A WTRU may provide assistance information to the gNB. This information may include the measurement-based data and/or non-measurement-based data as discussed herein. The WTRU may be operating in dual connectivity mode for CPC and/or may initiate dual connectivity for CPA.

The network may provide a coverage ensemble to the WTRU which, for example may provide the coverage indication for different cells and/or nodes. The WTRU may be provided with a set of PSCells near a WTRU's actual position and/or their suitable coverage areas. The suitable coverage area may include an indication in terms of position/location of different gNBs/TRPs and/or the orientation for different beams transmitted from these locations. The position and/or location information may be used to compute the distance of a WTRU from different gNBs/TRPs and/or may cover the translational mobility related cell/node changes that a WTRU may have. The translation mobility determination may be with reference to (e.g., based on) the actual position of a WTRU. The translation mobility indication may be provided in terms of absolute position. The absolute position may be the GPS coordinates which, for example may be associated with each beam of each configured PSCell.

The orientation indication may cover the rotational movement of a WTRU which, for example may happen with or without a translational movement. The orientation indication may be provided for one or multiple beams, for example from each configured PSCell. The orientation indication may be in the form of angular coverage, for example with respect to a suitable reference direction. The reference direction may be a known reference, and/or it may be provided as part of the configuration within the coverage ensemble. The reference direction may be associated with a reference beam and/or its indication may be part of the configuration. The reference beam may be defined as an SSB beam and/or a CSI-RS beam. The reference beam may be the actual beam through which the network is serving a WTRU. This reference beam may be the beam of PCell from MCG and/or the current PSCell of SCG. Alternatively, or additionally to the reference beam, a reference direction may be specified, for example using other approaches (e.g., geographical north or some other reference which is understandable to both the network and a WTRU). Orientation information may be given with respect to one or more configured transmission configuration indication (TCI) states where. A TCI state may include quasi co location (QCL) reference information, for example with a DL and/or UL beam/RS of a cell.

For each configured CPC candidate cell (e.g., which may include one or more beams for the cell), the network may provide the relevant parameters to trigger CPC. Additionally, or alternatively, for each configured CPC candidate cell the network may provide an angular span around a WTRU. Parameters may include (e.g., contention free) RACH preambles, for example within that (e.g., cell, beam) pair. This may include the RACH parameters (e.g., RACH preamble sequence identity, RACH duration, power ramping parameters, the parameters related to RACH occasions associated to the indicated beam, and/or etc.).

The configuration may additionally, or alternatively, include the conditions under which the configuration stays valid. The configuration may have a timer and/or the validity may expire upon the expiry of a timer. Another configuration release condition may be associated with the mobility. For example, if the configured device moves away from its last known position/location by more than a configured threshold, it may release the configuration. If a WTRU moves out of its current zone, the WTRU may release the configuration. The configuration may be valid in the current zone and/or direct neighbors having overlapping boundaries. If a WTRU moves out of direct neighbor zones, the WTRU may release the configuration. Another example where the configuration release condition may be associated with the device's timing advance value (e.g., with the serving gNB). For example, if the device moves and/or the change in the timing advance is above a configured threshold, the device may be configured to release the current active configuration. Another condition to release the configuration may be if the WTRU undergoes one or more of a MN change, and/or a SN change. Any suitable combination of parameters from the assistance information may be used to define the validity conditions and/or the release conditions.

The network deployment of beams may follow certain rules. A rule may be provided to a WTRU (e.g., in a compact form), for example for systems based upon ultra-massive MIMO having the capability of deploying thousands of beams per TRP. The beam deployment for a TRP may follow a pattern in azimuthal and/or elevation dimensions. A set of patterns may be known in tabular forms and/or through formulae. The network may choose a suitable pattern for its deployment, for example according to its requirements in a given geographic area. For cell and/or beam deployments for example, the network may provide the compact form of deployment pattern to WTRU (e.g., as part of the proactive CPC configuration). The configuration may include the positions of TRPs, for example in suitable coordinates for CPC candidate (e.g., cell, beam) pairs. A WTRU receiving a configuration may determine the nearest TRPs for any location relevant for each candidate (e.g., cell, beam) pair and/or (e.g., then) determine the suitable candidate (e.g., cell, beam) matching its updated geographic coordinates.

If a WTRU undergoes compromised link quality over its link to the PSCell for example, the WTRU may extract the information from local sensors. The WTRU may combine this with other radio measurements. Translation movement information may come from the local GPS receiver. The rotational movement may come from gyroscope and/or other components. A WTRU may compute its new geographic coordinates and/or orientation. These may be used to find the suitable CPC candidate (e.g., cell, beam) pair from the network, for example provided mapping of (e.g., cell, beam) pairs and/or geographic coordinates and/or orientation. This may let a WTRU know (e.g., precisely) which beam of a suitable cell from a suitable TRP it should have line-of-sight connection with respect to its updated coordinates. A WTRU may not need to perform one or more of cell searches, measurements, and/or network reporting, for example to find which beams of which cells may be (e.g., most) suitable to become target PSCell after undergoing a mobility event.

After having derived the suitable CPC (e.g., cell, beam) pair from the network provided configuration for example, a WTRU may evaluate the configured CPC conditions with this target candidate. If the CPC trigger condition is satisfied for example, a WTRU may send (e.g., contention free) RACH. RACH may be sent with the configured RACH parameters, for example over the configured RACH resources provided as part of the determined CPC candidate configuration.

A WTRU may derive the information from radio measurements and/or non-radio measurements, for example to aid in mobility procedures. The information derived from non-radio measurements may include geographic coordinates and/or orientation, and/or may let the WTRU determine its current zone. The zone determination may be based on one or more of geographic coordinates, orientation, and/or the zone configuration which, for example may be provided as part of ensemble configuration. The WTRU may use the determined zone to derive the suitable cell(s) serving the determined zone from the ensemble information. A WTRU may be configured by the network with a measurement configuration, for example wherein the conditional events (e.g., event CM1 and/or event CM2, detailed herein), may be configured. When the relevant conditions for these events are fulfilled for example, a WTRU may determine the change of its current zone. A WTRU may determine its new zone, that for example may allow it to perform one or more of deriving the suitable (e.g., cell, beam) pair from the coverage ensemble corresponding to this updated zone, validating the CPC candidate (e.g., cell and relevant beam) from radio signal measurements, and/or initiating the CPC procedure with the successful candidate fulfilling the execution conditions. The same may be achieved by the network configuring the WTRU with events which, for example may have conditions composite over radio and/or non-radio measurement quantities. These events may be defined as J1, J2, J3, and/or J4 herein.

The network (e.g., base station) may broadcast coverage ensemble information. A new coverage ensemble system information block (SIB) may be specified. For example, the coverage ensemble information broadcasted by a cell or a TRP may be configured to reflect the local deployment environment of the cell and/or TRP broadcasting the coverage ensemble. A coverage ensemble may be associated with an area denoted here coverage ensemble area. A coverage ensemble area may correspond to one or more cells, a RAN Notification Area (RNA), a tracking area (TA), a PLMN, and/or etc. The coverage ensemble broadcast signaling may provide the configuration of zones with suitable granularities. The WTRU may receive the coverage ensemble area configuration information in the coverage ensemble SIB, and/or through a new SIB dedicated to coverage ensemble area signaling that, for example may be denoted here coverage ensemble area SIB. The WTRU may additionally, or alternatively, receive the coverage ensemble area information through dedicated RRC signaling (e.g., RRC reconfiguration message). Upon detection of change in coverage ensemble area for example, the WTRU may re-acquire a coverage ensemble for its current location, for example by re-acquiring the coverage ensemble SIB, and/or through dedicated RRC signaling exchange with the network (e.g., base station).

The WTRU may use the information from its local sensors and/or interfaces to extract its mobility information (e.g., speed, direction, angular rotation, etc.), and/or current geographic parameters, for example its location information including one or more of absolute position, relative positions to objects or other geographical markers, its mobility parameters, its capability parameters, and/or etc. Such information may allow a WTRU to determine a suitable candidate (e.g., cell, beam) pair from the coverage ensemble. A WTRU may determine the change in its current zone, for example by using suitable events on non-radio measurements. With the updated zone information for example, a WTRU may determine the suitable CPC candidate (e.g., cell, beam pair) from the ensemble information which corresponds to its updated zone. The WTRU may validate the candidate (e.g., cell, beam) pair through radio signal measurements received from the candidate (e.g., cell, beam) pair and/or initiate the CPC/CPA procedure as per the configuration. Events which combine the radio and non-radio measurement quantities in the form of suitable conditional events may be used. Some examples of joint events (e.g., J1, J2, J3, and/or J4) are provided herein.

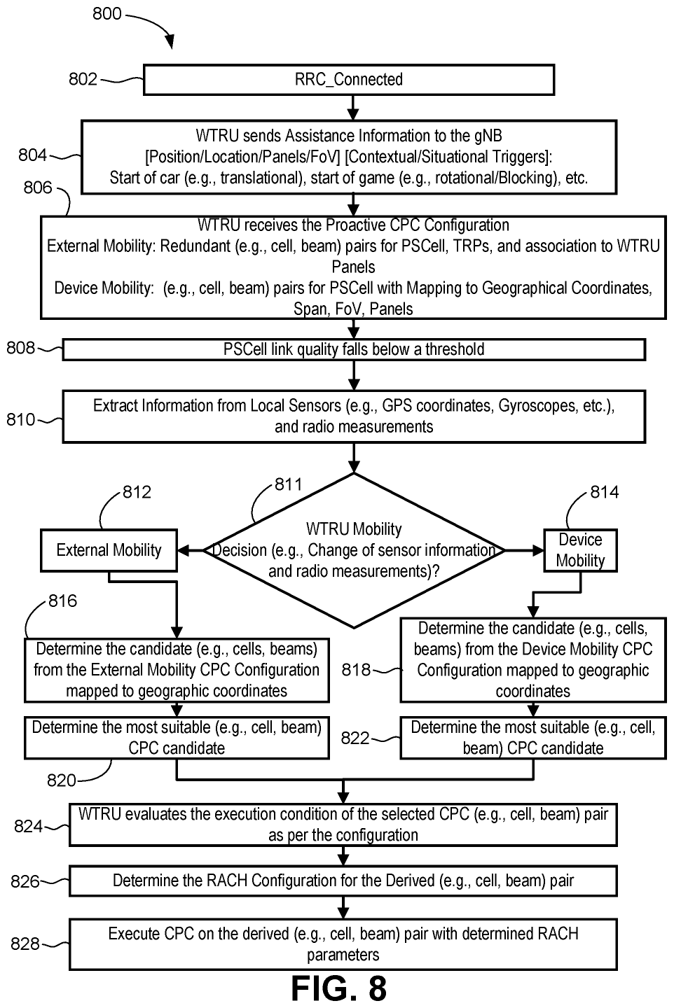

FIG. 8 depicts an example flow chart for the proposed proactive conditional PSCell change procedure 800. At 802 a WTRU may be RRC_CONNECTED. For an RRC_CONNECTED WTRU with dual connectivity whether EN-DC or MR-DC for example, the WTRU may send the advanced assistance information to the network/gNB at 804. The assistance information may indicate that the WTRU can use sensor data for mobility. For example, the assistance information may include the information from local sensors, e.g., position sensors, gyroscope, accelerometer, and/or etc. Additional or alternative groups and/or constituent elements for WTRU assistance information are discussed herein.

Based upon the WTRU assistance information, network deployment of TRPs, cells and beams, WTRU profile for services and mobility, QoS requirements for the services/applications a WTRU is using for example, the network may provide suitable configuration to WTRU for proactive CPC at 806. For example, the WTRU may receive CPC configuration information from the network. The configuration may include the candidate cells and/or beams and/or suitable mapping of these candidate (e.g., cell, beam) pairs to suitable geographic coordinates and/or orientations. The configuration may include the parameters and/or thresholds for a WTRU to derive its zone/location/position and span, for example so as to determine the suitable (e.g., cell, beam) pair from the mapping table. The configuration may provide two sets of sub-configurations. One sub-configuration may handle the device mobility where the device may be undergoing translational and rotational movements. Another sub-configuration may focus on the external mobility where, for example the interruptions may be originated from the environment and not the result of direct device mobility. As an example, the external mobility resulting from mobile blockers may provide the (e.g., cell, beam) pairs which are able to provide the coverage to the target device with its known location/position at the network when the serving cell degrades and/or undergoes failure. As such, the CPC configuration information may include a CPC candidate for device mobility and/or a CPC candidate for external mobility (e.g., a pair). Additionally, or alternatively, the CPC configuration information may include a CPC for device mobility and/or a CPC for external mobility. Further, in some examples, the CPC configuration may include a trigger for performing CPC based on the assistance information. The WTRU may switch and/or activate to a different panel where, for example a gNB may provide the indication as part of configuration. This indication may be based on the WTRU providing the implementation and/or capabilities of its antenna panels and/or detailed feature set as part of its assistance information.

For proactive CPC for example, the procedure may be initiated by the master node and/or through the secondary node. When initiated by the SN for example, the procedure may involve the signaling with or without involving the master node. The systems and procedures herein are applicable to the case when PSCell change involves the change of the secondary node, and/or the procedure may can be triggered by either of the master and/or secondary node. The WTRU may perform a CPC, for example based on a cell quality of a serving cell being below a threshold. The threshold may be a configured and/or quality threshold as described herein. The WTRU may determine whether to use the CPC candidate for device mobility and/or the CPC candidate for external mobility based on the sensor data and/or the trigger, for example to perform the CPC. Additionally, or alternatively, the WTRU may determine whether to use the CPC candidate for device mobility and/or the CPC candidate for external mobility based on a location of the WTRU. The location of the WTRU may be determined using the sensor data and/or a trigger. Sensor data may include information from local sensors, e.g., position sensors, gyroscope, accelerometer, and/or etc. A trigger may include radio measurement(s) and/or non-radio measurement quantitie(s). The non-radio measurement may include one or more of a rotation measurement of the WTRU, an orientation measurement of the WTRU, a location measurement of the WTRU, and/or a velocity measurement of the WTRU.

The network may provide a set of CPC configurations to a WTRU. The network may provide the association of these configurations to different suitable criteria, for example including one or more of WTRU active applications, QoS (e.g., different reliability requirements), different power consumption targets at WTRU, WTRU active service subscription level, and/or etc. When a WTRU is undergoing link failure and/or compromised link quality for its PSCell link for example, a WTRU may use the suitable configuration according to the current situation as per the configured criterion. As described herein, multiple configurations may be associated with one or more of different physical parameters (e.g., such as external or device mobility), different service reliability targets (e.g., one configuration while higher reliability is required and once configuration for lower reliability), different subscription levels (e.g., one configuration when WTRU is using paid content vs one configuration for the non-paid-content), and/or etc.

A PSCell link quality may fall below a threshold at 808. When a WTRU is facing a compromised PSCell link quality according to the configured quality threshold(s) for example, a WTRU may extract the information from its local sensors (e.g., non-radio measurements) at 810. The sensor information may be combined with measurements performed using the new and/or existing reference signals received from the network. One example may be to combine information with measurements performed using the downlink positioning reference signals. At 811, the WTRU may make a mobility decision. For example, the WTRU may decide whether to change sensor information and/or radio measurements. A WTRU may use this information to select the suitable CPC (e.g., cell, beam) candidate pair from the device mobility at 814 and/or external mobility configuration at 812. A WTRU may assemble the information from local sensors to the suitable format of location/zone/orientation, for example as per the selected suitable configuration, and/or (e.g., then) derive its location/orientation. The WTRU may determine a zone of the WTRU, for example based on the coverage information and a location of the WTRU. The WTRU may determine whether to use the CPC candidate for device mobility and/or the CPC candidate for external mobility based on the determined zone. The WTRU may determine a zone of the WTRU and/or determine whether to use the CPC candidate for device mobility and/or the CPC candidate for external mobility based on the determined zone to perform the CPC.

The WTRU may determine the candidate from the external mobility CPC configuration at 816 and/or at 818, for example mapped to geographic coordinates. The WTRU may determine the candidate from the device mobility CPC configuration, for example mapped to geographic coordinates. With this location/orientation for example, a WTRU may determine the suitable (e.g., cell, beam) pair from the configured mapping at 820 and/or at 822.

At 824 the WTRU may (e.g., then) evaluate the configured CPC execution condition, for example as per the configuration. The execution conditions may be specified through, for example a suitable configuration of conditional event A3, conditional event A5, and/or new suitable conditionals events (e.g., as herein). Conditional event A3 may be defined as a case when a candidate CPC cell (e.g., with a suitable beam) becomes an offset better than current SpCell, (e.g., primary cell of the secondary cell group). Conditional event A5 may be defined with two conditions. One condition may be defined for the SpCell becoming worse than a configured threshold. The second condition may be specified for the CPC candidate becoming better than another configured threshold. For the target use cases spanning ultra-massive MIMO beams having variety of deployment possibilities including layered and hierarchical architectures for example, new reference signals may be designed to suitably and/or rapidly identify, detect, and/or measure such beams. These reference signals may (e.g., then) be used to identify (e.g., cell, beam) pairs and/or may be provided as part of network configuration. The quality criterion and/or CPC execution conditions (e.g., conditional events on non-radio measurements as herein and/or conditional events on radio measurements quantities like legacy events A3/A5 or newly designed) may (e.g., then) be specified in terms of new reference signals. New composite events may be specified which, for example may combine the triggering conditions as combination of radio measurements and/or non-radio measurement quantities. At 826 the WTRU may determine a RACH configuration for the derived pair. The WTRU may execute CPC on the derived pair at 828, for example with the determined RACH parameters.

Some of the examples of non-radio measurement quantities that WTRUs may have access through local sensors or non-3GPP interfaces are described herein. Non-radio measurement quantities may (e.g., then) be used in one or more of in combination with radio measurement quantities, for example in preparation of refined coverage ensembles, in events triggered by certain values/conditions over these non-radio measurement quantities alone and/or in composite events where radio and/or non-radio measurement quantities are combined to trigger suitable events. These quantities, triggers and/or events may (e.g., then) be used in WTRU autonomous mobility, for example supported by network provided configurations.

Rotation estimation may be helpful to analyze whether the device may be within suitable angular range of a given cell/beam. For example if the device is within a suitable angular range, the device may not need to trigger certain measurement reports, not need to activate different antenna panels, and/or not need to make measurements from other panels in potential switch over to neighboring beam/cell/node. Absolute orientation estimation may be helpful to consider antenna panel switching to potentially switch to different TRPs.

Speed/Velocity triggers may be used, for example where the network may provide configuration to WTRUs where a cell configuration indicates that a given beam has (e.g., very) limited range and/or cell coverage is very limited. The beam may not be a suitable candidate for beam recovery, for example, if a WTRU is moving (e.g., very) fast and/or may be out of the beam coverage before/during the beam recovery procedure. Similarly, such cells may not be suitable candidates for CHO/CPC if a WTRU is moving with high speed. Some CPC candidate cells with specific beams, (e.g., cell-beam pairs) may be marked as favorable and/or not favorable for different speed/velocity ranges. The WTRU may determine whether to use the CPC candidate for device mobility and/or the CPC candidate for external mobility based on a priority of CPC candidate pairs, for example to perform the CPC. The CPC configuration information may include a priority. The priority may be related to the CPC candidate for device mobility and/or a priority related to the CPC candidate for external mobility. The favorable and/or not favorable indications may be useful, for example when different beams from a given cell may have different coverage features. High velocity WTRUs may skip (e.g., very) small cells and/or cell-beam pairs that, for example may require large number of transition-events and/or may connect and get served through macro cells. The network may provide these attributes with the cells/beam, for example so that WTRUs may evaluate local metrics and/or choose a suitable target cell for the execution of conditional configuration. The WTRU may determine a random access channel (RACH) parameter based on the CPC configuration information based on a selected CPC candidate, for example to perform the CPC. The WTRU may perform the CPC to the selected CPC candidate using the determined RACH parameter.

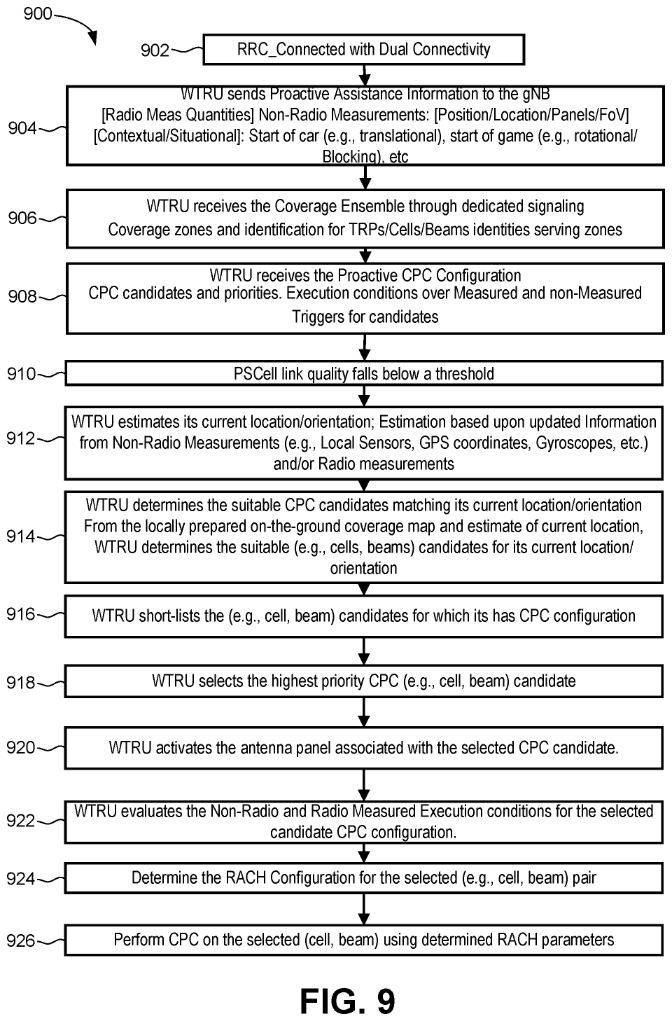

FIG. 9 depicts an example Proactive CPC 900 with Coverage Ensemble as Dedicated Signaling. The example proactive CPC 900 may be performed by a WTRU undergoing link failure on PSCell. A WTRU may be RRC_CONNECTED with dual connectivity at 902. At 904 the WTRU may send the (e.g., proactive) assistance information to the gNB. The assistance information may include one or more of Radio-measurement-quantity-based-data, non-radio-measurement-quantity-based-data, and/or WTRU-capability-and-Implementation-details.

The gNB may transmit a coverage ensemble through WTRU dedicated signaling with suitable cell/beam level granularity with zone indications. At 906 the WTRU may receive the local coverage ensemble transmitted by the network, for example through dedicated signaling. The local coverage ensemble may include a local snapshot of different zones at cell/beam level granularity with identification of the coverage of different zones. The local coverage ensemble may include the cells/beams associated to each zone.

The gNB may prepare a set of suitable Proactive CPC configurations and/or may transmit the set of configurations to a WTRU. At 908 the WTRU may receive the Proactive CPC configuration from the gNB. The proactive CPC configuration may include one or more of a set of CPC candidate (e.g., cell, beam) pairs, a priority of (e.g., cell, beam) pairs, and/or a conditional configuration with joint events having triggers over radio measurement and non-radio measurement quantities. When a WTRU is undergoing compromised PSCell link quality (e.g., cell quality going below a configured threshold) for example, the WTRU may start a Proactive conditional PSCell change. The Proactive conditional PSCell change may include the WTRU receiving information from local sensors (e.g., such as GPS, Accelerometer, Gyroscope, etc.), which for example may be combined with radio measurements. The WTRU may determine current values for the WTRU's location/orientation parameters. A PSCell link quality may fall below a threshold at 910. At 912 the WTRU may determine its current zone in the coverage ensemble, for example using the estimated values of its location/orientation and zone configuration. At 914 the WTRU may determine the suitable candidate (e.g., cell, beam) pairs corresponding to its determined zone in the local copy of the received coverage ensemble. At 916 the WTRU may short-list the (e.g., cell and/or beam) candidates, for example for which it has CPC configuration. At 918 the WTRU may select the highest priority CPC (e.g., cell and/or beam) candidate. At 920 the WTRU may activate the antenna panel associated with the selected CPC candidate. At 922 the WTRU may evaluate the configured execution conditions for the target CPC candidate which, for example may be a combination and/or composite over radio and/or non-radio measurements (e.g., Proposed Events OD1/2-combined with Legacy Events A3/A4/A5, etc). When execution conditions are fulfilled for example, the WTRU may determine a RACH configuration from the conditional configuration corresponding to the selected CPC (e.g., cell, beam) pair at 924. At 926 the WTRU may perform the conditional CPC on the target candidate (e.g., cell, beam) pair using the determined RACH parameters.

The WTRU may be configured with multiple sets of CPC configurations. The multiple sets of CPC configurations may be associated to suitable criteria. The network may provide two sets of conditional handover configurations which, for example may be associated with Device Mobility and External Mobility. The WTRU may determine the suitable configuration to use, for example by determining the cause of mobility as device mobility or external mobility from the local sensors' measurements. The sets of CPC configurations may be indicated to be associated with different levels of QoS requirements, for example of specific applications/services running at WTRU device. The sets of CPC configurations may be indicated to be associated with different WTRU power consumption requirements. The sets of CPC configurations may be indicated to be associated with WTRU subscription. The sets of CPC configurations may be associated with the different values of WTRU speed/velocity estimates.

The network provided ensemble may include one or more deployment parameters of its cells, TRPs, and/or beam relevant parameters. The WTRU may perform post-processing on the deployment ensemble, for example received from the network to fabricate the effective coverage ensemble. The WTRU post-processing on the deployment ensemble may use the information from its local sensors to fabricate the effective coverage ensemble. The WTRU post-processing on the deployment ensemble may use the locally stored information to fabricate the effective coverage ensemble. Topographical and/or terrain related ensembles may be used which, for example may be available in the local storage and/or through some other source. The Proactive CPC configuration for a CPC candidate may indicate to a WTRU to activate one or more (e.g., specific) available antenna panels. The WTRU may validate the execution condition through the indicated antenna panel. The WTRU may initiate the CPC procedure with the successful configuration/candidate using the indicated antenna panel. A different antenna panel activation may have other conditions configured which, for example, may ensure that the link to the master cell group stays intact despite the change of panel for the candidate PSCell.

If execution conditions are not fulfilled for the selected CPC candidate, the WTRU may remove this candidate from a short-listed candidates which, for example may provide coverage in its on-the-ground coverage ensemble and/or for which it has received CPC configuration. A WTRU may (e.g., then) select the highest priority CPC candidate from the remaining short-listed candidates and/or performs subsequent steps.

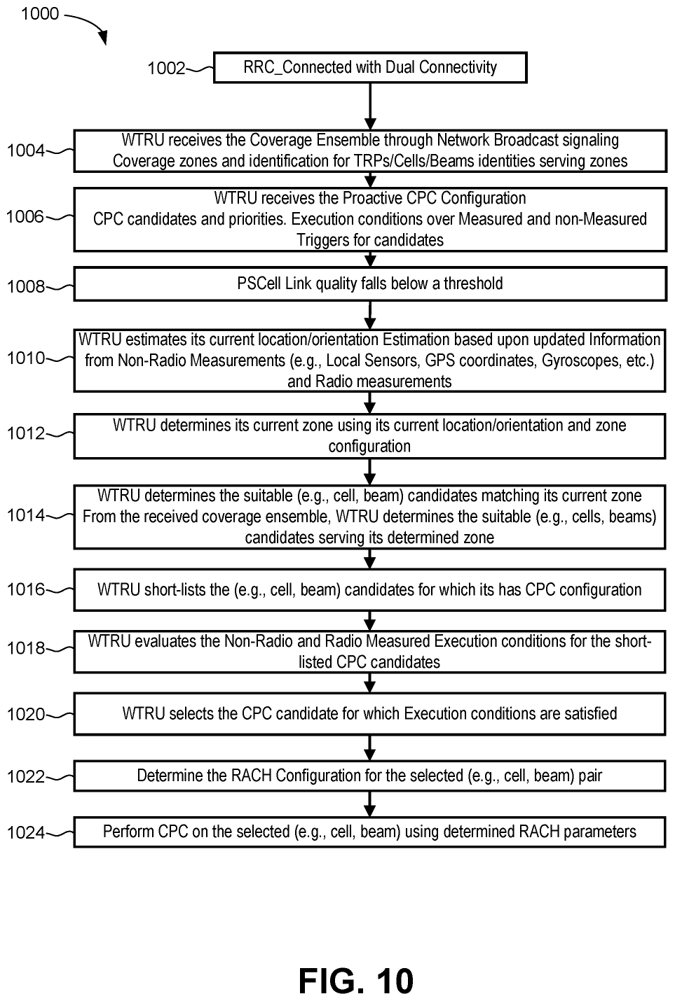

FIG. 10 depicts an example Proactive CPC 1000 with SIB based Coverage Ensemble. The example Proactive CPC 1000 may be performed by a WTRU undergoing link failure on PSCell. A WTRU may be RRC_CONNECTED with dual connectivity at 1002. At 1004 the WTRU may receive the coverage ensemble transmitted by the network, for example, as part of a system information broadcast. The coverage ensemble may include a local snapshot of different zones at cell/beam level granularity, for example with identification of the coverage of different zones and/or one or more cell and/or beam pairs associated with each zone.

The gNB may prepare a set of suitable Proactive CPC configurations and/or transmit the set of configurations to a WTRU. A WTRU may receive a Proactive CPC configuration from the gNB at 1006. The Proactive CPC configuration may include one or more of a set of CPC candidate (e.g., cell, beam) pairs, a priority of (e.g., cell, beam) pairs, and/or a conditional configuration, for example with joint events having triggers over radio measurement and non-radio measurement quantities.

If for example a WTRU is undergoing compromised PSCell link quality (e.g., cell quality going below a configured threshold), the WTRU may start a Proactive conditional PSCell change. The proactive conditional PSCell change may include the WTRU receiving information from local sensors (e.g., GPS, Accelerometer, Gyroscope, etc.), which may be combined with radio measurements. A PSCell link quality may fall below a threshold at 1008. The WTRU may determine the current values for its location/orientation parameters at 1010. At 1012 the WTRU may find its current zone in the coverage ensemble using the its current location/orientation and zone configuration. The WTRU may determine the suitable candidate (e.g., cell, beam) pairs corresponding to its determined zone at 1014, for example in the local copy of the received coverage ensemble. At 1016 the WTRU may short-list the (e.g., cell and/or beam) candidates, for example for which it has CPC configuration. At 1018 the WTRU may evaluate the configured execution conditions for the target CPC candidate which, for example may be in combination and/or composite over radio and/or non-radio measurements (e.g., Proposed Events OD1/2-combined with Legacy Events A3/A4/A5, etc.). The WTRU may select the highest priority CPC (e.g., cell and/or beam) candidate at 1020.

When execution conditions are fulfilled for example, at 1022 the WTRU may determine the RACH configuration from the conditional configuration corresponding to the selected CPC (e.g., cell, beam) pair. At 1024 the WTRU may perform the conditional CPC on the target candidate (e.g., cell, beam) pair, for example using the determined RACH parameters.

The WTRU may be configured with two sets of CPC configurations. The two sets of conditional handover configurations may be associated with Device Mobility and External Mobility. The WTRU may determine the suitable configuration to use by determining the cause of mobility as device mobility or external mobility from the local sensors' measurements. The sets of CPC configurations may be indicated to be associated to QoS requirements, for example of specific applications/services running at WTRU device. The sets of CPC configurations may be indicated to be associated with WTRU power consumption requirements. The sets of CPC configurations may be indicated to be associated with WTRU subscription. The sets of CPC configurations may be associated with the WTRU speed/velocity.

The network provided ensemble may include deployment parameters of its cells, TRPs, and/or beam relevant parameters. The WTRU may perform post-processing on the deployment ensemble, for example received from the network to fabricate the effective coverage ensemble. The WTRU post-processing on the deployment ensemble may use the information from its local sensors, for example, to fabricate the effective coverage ensemble. The WTRU post-processing on the deployment ensemble may use the locally stored information to fabricate the effective coverage ensemble. One example may be to use the topographical and/or terrain related ensembles which may be available in the local storage and/or through some other source.

The Proactive CPC configuration may indicate to a WTRU to activate one or more (e.g., specific) available antenna panels. The WTRU may validate one or more execution conditions, for example through the indicated antenna panel. The WTRU may initiate the CPC procedure with the successful configuration/candidate using the indicated antenna panel. A different antenna panel activation may have other conditions configured which, for example may ensure that the link to the master cell group stays intact despite the change of panel for the candidate PSCell.

If execution conditions are not fulfilled for the selected CPC candidate for example, a WTRU may remove this candidate from its short-listed candidates which provide coverage in its on-the-ground coverage ensemble and/or for which it has received CPC configuration. The WTRU may (e.g., then) select the highest priority CPC candidate from the remaining short-listed candidates and/or perform subsequent steps.

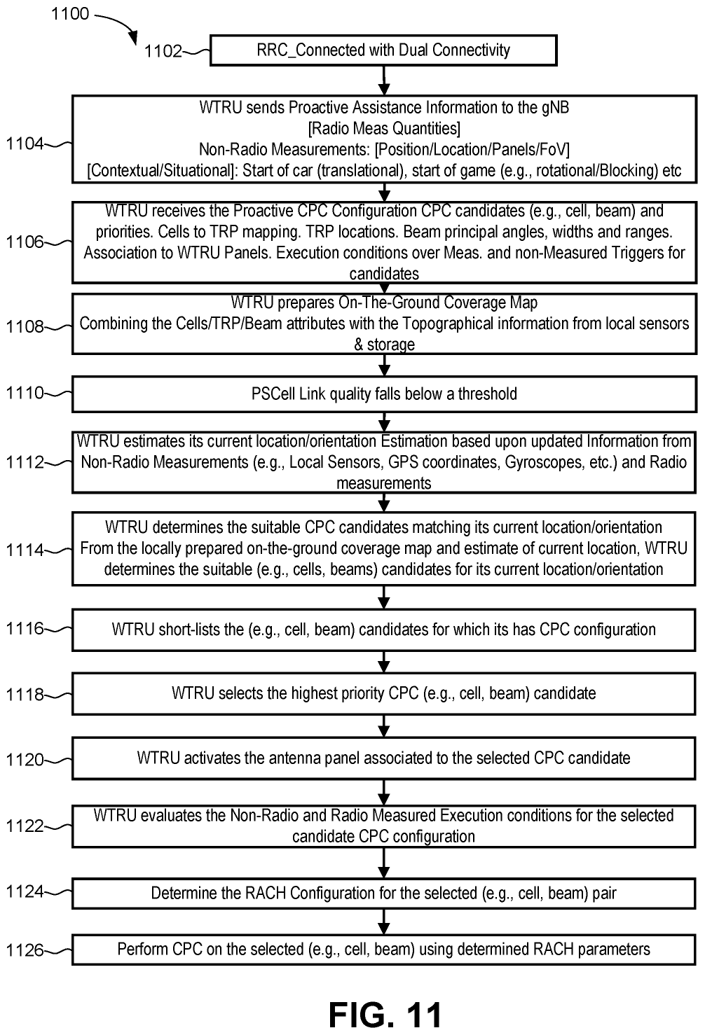

FIG. 11 depicts an example proactive CPC 1100 with Ensemble Indication as part of Proactive CPC Configuration. The example proactive CPC 1100 with proactive switch of the secondary cell group may be performed by a WTRU undergoing a conditional PSCell change procedure. At 1102 a WTRU may be RRC_CONNECTED with dual connectivity. The conditional PSCell change may include one or more of the following. A WTRU may send Assistance Information to the gNB at 1104 (e.g., master gNB and/or secondary gNB). The assistance information may include one or more of radio-measurement-quantity-based-data, non-radio-measurement-quantity-based-data, and/or WTRU-capability-and-Implementation-details. The gNB may prepare a set of suitable Proactive CPC configurations based upon the WTRU assistance information, WTRU profile, and/or the network deployment/configuration. The gNB may transmit the set of suitable proactive CPC configurations to a WTRU.

A WTRU may receive a Proactive CPC configuration from the gNB at 1106. The proactive CPC configuration may include one or more of the following. The proactive CPC configuration may include a set of CPC candidate (e.g., cell, beam) pairs. The proactive CPC configuration may include TRP locations, association of cells with TRPs, set of beams for each candidate cell with suitable angular coordinates (e.g., azimuthal and elevation angles), beam widths in horizontal and vertical planes, and/or beam range parameters. The configuration (e.g., this part of the configuration) may provide the association of TRPs/cells/beams with cells and beam identities. The proactive CPC configuration may include a mapping of each candidate (e.g., cell, beam) pair to geographic coordinates and/or orientation for Device Mobility and/or External Mobility. The proactive CPC configuration may include a priority of (e.g., cell, beam) pairs, for example for cases when multiple (e.g., cell, beam) pairs may have overlap over geographic zones/orientations. The proactive CPC configuration may include conditional configuration with events having triggers over radio measurement and/or non-radio measurement quantities.

At 1108 the WTRU may prepare the On-The-Ground coverage ensemble using the deployment information from the network and/or topographical information from its local storage/sensors. As part of the coverage ensemble fabrication, the WTRU may build the zones as per the configuration signaling. When the WTRU is undergoing compromised PSCell link quality (e.g., cell quality going below a configured threshold) for example, the WTRU may start the Proactive conditional PSCell change. The Proactive conditional PSCell change may include one or more of the following. The WTRU may receive the information from local sensors (e.g., GPS, Accelerometer, Gyroscope, etc.), for example combined with radio measurements. The WTRU may determine the current values for its location/orientation parameters. A PSCell link quality may fall below a threshold at 1110. At 1112 the WTRU may find its current zone in the coverage ensemble, for example using the estimated values of its location/orientation.

At 114 the WTRU may determine one or more suitable candidate (e.g., cell, beam) pairs corresponding to its determined zone in its locally prepared On-The-Ground Coverage ensemble. The WTRU may short-list the candidates which are part of the CPC configuration at 1116. At 118 the WTRU may select the highest priority CPC candidate (e.g., cell, beam) among the determined candidates. The WTRU may activate the antenna panel associated with the selected CPC candidates at 1120.

At 1122 the WTRU may evaluate the configured execution conditions for the target CPC candidate which, for example may be in combination and/or composite over radio and/or non-radio measurements (e.g., Proposed Events OD1/2-combined with Legacy Events A3/A4/A5 etc). When one or more execution conditions are satisfied for example, the WTRU may determine the RACH configuration from the conditional configuration corresponding to the selected CPC (e.g., cell, beam) pair at 1124. At 1126 the WTRU may perform the conditional CPC on the target candidate (e.g., cell, beam) pair using the determined RACH parameters.

The WTRU may be configured with two sets of CPC configurations. The two sets of conditional handover configurations may be associated with Device Mobility and External Mobility. The WTRU may determine the suitable configuration to use by determining the cause of mobility as device mobility and/or external mobility from the local sensors' measurements. The sets of CPC configurations may be indicated to be associated with QoS requirements, for example of specific applications/services running at WTRU device. The sets of CPC configurations may be indicated to be associated with WTRU power consumption requirements. The sets of CPC configurations may be indicated to be associated with WTRU subscription. The set of CPC configurations may be associated with the WTRU speed/velocity. A unified configuration (e.g., only one unified configuration) may be provided to a WTRU. A different antenna panel activation may have other conditions configured which, for example, may ensure that the link to the master cell group stays intact despite the change of panel for the candidate PSCell.

When one or more execution conditions are not fulfilled for the selected CPC candidate, the WTRU may remove the selected candidate from its short-listed candidates which, for example may provide coverage in its on-the-ground coverage ensemble and/or for which it has received CPC configuration. The WTRU may select the highest priority CPC candidate from the remaining short-listed candidates and/or may perform subsequent steps.

What is claimed is:

1-20. (canceled)

21. A wireless transmit/receive unit (WTRU) comprising:
a processor configured to:
send assistance information to a network element, the assistance information indicating that the WTRU can use sensor data for mobility;
receive conditional PSCell change (CPC) configuration information from the network element, the CPC configuration information comprising a CPC candidate for device mobility, a CPC candidate for external mobility, and a trigger for performing CPC based on the assistance information; and
perform a CPC based on a cell quality of a serving cell being below a threshold, wherein to perform CPC, the processor is configured to determine whether to use the CPC candidate for device mobility or the CPC candidate for external mobility based on the sensor data and the trigger.

22. The WTRU of claim 21, wherein the CPC configuration information comprises at least one of a priority related to the CPC candidate for device mobility or a priority related to the CPC candidate for external mobility.

23. The WTRU of claim 21, wherein the trigger for performing CPC is based on at least one radio measurement or non-radio measurement.

24. The WTRU of claim 21, wherein the processor is configured to receive coverage information from the network element, wherein the coverage information comprises an indication of different zones, a coverage area of the different zones, and at least one of a cell or beam associated with each of the different zones.

25. The WTRU of claim 24, wherein the processor is configured to perform CPC by being configured to:
determine a zone of the WTRU based on the coverage information and a location of the WTRU; and
determine whether to use the CPC candidate for device mobility or the CPC candidate for external mobility based on the determined zone.

26. The WTRU of claim 21, wherein the processor is configured to perform CPC by being configured to:
determine a random access channel (RACH) configuration based on the CPC configuration information; and
perform the CPC to the determined CPC candidate for device mobility or the CPC candidate for external mobility using the determined RACH configuration.

27. The WTRU of claim 21, wherein the assistance information comprises an indication that the WTRU can use at least one of Global Positioning System (GPS) data, location data, position data, orientation data, velocity data, accelerometer data, or gyroscope data for mobility.

28. The WTRU of claim 27, wherein the processor is further configured to receive coverage information from the network element, wherein the coverage information is based on the indication comprised in the assistance information.

29. The WTRU of claim 21, wherein the processor is configured to receive coverage information in broadcast system information (SIB).

30. The WTRU of claim 21, wherein the CPC configuration information comprises a plurality of CPC candidates and respective coverage information associated with each CPC candidate of the plurality of CPC candidates.

31. A method implemented by a wireless transmit/receive unit (WTRU), the method comprising:
sending assistance information to a network element, the assistance information indicating that the WTRU can use sensor data for mobility;
receiving conditional PSCell change (CPC) configuration information from the network element, the CPC configuration information comprising a CPC candidate for device mobility, a CPC candidate for external mobility, and a trigger for performing CPC based on the assistance information; and
performing a CPC based on a cell quality of a serving cell being below a threshold, wherein performing the CPC comprises determining whether to use the CPC candidate for device mobility or the CPC candidate for external mobility based on the sensor data and the trigger.

32. The method of claim 31, wherein the CPC configuration information comprises at least one of a priority related to the CPC candidate for device mobility or a priority related to the CPC candidate for external mobility.

33. The method of claim 31, wherein the trigger for performing CPC is based on at least one radio measurement or non-radio measurement.

34. The method of claim 31, comprising receiving coverage information from the network element, wherein the coverage information comprises an indication of different zones, a coverage area of the different zones, and at least one of a cell or beam associated with each of the different zones.

35. The method of claim 34, wherein performing CPC comprises:
determining a zone of the WTRU based on the coverage information and a location of the WTRU; and
determining whether to use the CPC candidate for device mobility or the CPC candidate for external mobility based on the determined zone.

36. The method of claim 31, wherein performing CPC comprises:
determining a random access channel (RACH) configuration based on the CPC configuration information; and
performing the CPC to the determined CPC candidate for device mobility or the CPC candidate for external mobility using the determined RACH configuration.

37. The method of claim 31, wherein the assistance information comprises an indication that the WTRU can use at least one of Global Positioning System (GPS) data, location data, position data, orientation data, velocity data, accelerometer data, or gyroscope data for mobility.

38. The method of claim 37, comprising receiving coverage information from the network element, wherein the coverage information is based on the indication comprised in the assistance information.

39. The method of claim 31, comprising receiving coverage information in broadcast system information (SIB).

40. The method of claim 31, wherein the CPC configuration information comprises a plurality of CPC candidates and respective coverage information associated with each CPC candidate of the plurality of CPC candidates.
